(19) United States
(12) Patent Application Publication
(10) Pub. No.: US 2023/0103192 A1
(43) Pub. Date: Mar. 30, 2023

(54) TRANSACTION PROCESSING SYSTEM, INPUT PROCESSING DEVICE, SETTLEMENT DEVICE, AND PROGRAMS

(71) Applicant: TOSHIBA TEC KABUSHIKI KAISHA, Tokyo (JP)

(72) Inventor: Hiroyuki KATSUMATA, Numazu Shizuoka (JP)

(21) Appl. No.: 17/893,810

(22) Filed: Aug. 23, 2022

(30) Foreign Application Priority Data
Sep. 24, 2021 (JP) 2021-155651

(51) Int. Cl. G06Q 20/20; G06Q 20/10; G06Q 20/42

(52) U.S. Cl. CPC G06Q 20/202; G06Q 20/102; G06Q 20/42

(57) ABSTRACT

An input processing device transmits settlement information to a first settlement device set as a primary transmission destination of two settlement devices. An input processing device performs a status check on the first settlement device. Upon receiving a transmission destination change from the second settlement device of the two settlement devices, the input processing device changes the transmission destination for the settlement information to the second settlement device. The second settlement device sends a status check request for requesting a status check on the first settlement device to the input processing device. If a status check response regarding the first settlement device is returned from the input processing device satisfies a transmission destination change condition, the second settlement device sends a transmission destination change to the input processing device.

### CROSS-REFERENCE TO RELATED APPLICATION

This application is based upon and claims the benefit of priority from Japanese Patent Application No. 2021-155651, filed Sep. 24, 2021, the entire contents of which are incorporated herein by reference.

### FIELD

Embodiments described herein relate generally to a transaction processing system for retail store sales transactions and components of such a system such as an input processing device, a settlement device, and software programs for such components.

### BACKGROUND

In recent years, a semi-self-service type transaction processing system has been adopted as a transaction processing system for high volume retailers. In a transaction processing system of this type, an input processing device that receives data of a commodity being purchased in a transaction registers the commodity and a settlement device that executes settlement processing for the transaction based on the registration processing are separate devices. The input processing device and the settlement device are generally disposed such that a store clerk operates the input processing device and a customer operates the settlement device.

In a semi-self-service type transaction processing system, since the store clerk performs data input operation for a commodity, the time required for a data input is typically shorter than the time required for such registration processing in a full-self-service type transaction processing system in which the customer performs commodity registration operations by himself or herself. On the other hand, the customer who operates the settlement device is likely unaccustomed to the operation of the settlement device and thus takes more time in performing settlement operations than might otherwise be the case. Therefore, in general, the semi-self-service type transaction processing systems include, for example, two settlement devices for each input processing device.

The input processing device transmits settlement information necessary for settlement of a transaction to one settlement device (for example, a first settlement device of two). If the first settlement device has already finished settlement for the preceding customer and is now available of performing settlement processing, the first settlement device processes the settlement of a transaction based on the settlement information from the input processing device. If the first settlement device is still performing the settlement for the preceding customer and is thus incapable of performing settlement processing, the first settlement device transmits the settlement information to another settlement device (for example, a second settlement device of the two). The second settlement device processes the settlement of the transaction based on the settlement information received from the first settlement device. In this way, a semi-self-service type transaction processing system permits the two settlement devices to efficiently operate to make it possible to settle a large number of transactions in a short time.

However, in such existing systems, the transmission destination to which the input processing device can transmit the settlement information is limited to the first settlement device only. Therefore, if the first settlement device breaks down and cannot receive the settlement information, not only the first settlement device but also the second settlement device which receives its settlement information by forwarding from the first cannot process the settlement of a transaction. As a result, the settlement of customer transactions can be delayed.

### BRIEF DESCRIPTION OF THE DRAWINGS

FIG. 1 is a schematic diagram illustrating a schematic configuration of a transaction processing system according to a first embodiment.

FIG. 2 is a block diagram illustrating a registration machine.

FIG. 3 is a block diagram illustrating a checkout machine.

FIG. 4 is a schematic diagram illustrating a data structure of a connection state table.

FIG. 5 is a schematic diagram illustrating a checkout machine state flag included in a registration machine.

FIG. 6 is a flowchart illustrating a procedure of information processing executed by a processor of the registration machine.

FIG. 7 is a flowchart illustrating the procedure of t information processing executed by a processor of a registration machine.

FIG. 8 is a flowchart illustrating a procedure of information processing executed by a processor of a first-type checkout machine.

FIG. 9 is a flowchart illustrating a procedure of information processing executed by a processor of a second-type checkout machine.

FIG. 10 is a flowchart illustrating a procedure of an information processing executed by processors of a first-type checkout machine and a second-type checkout machine.

FIG. 11 is a flowchart illustrating a procedure of information processing executed by a processor of a registration machine.

FIG. 12 is a flowchart illustrating a procedure of information processing executed by processors of a first-type checkout machine and a second-type checkout machine.

FIG. 13 is a flowchart illustrating a procedure of information processing executed by a processor of a registration machine.

FIG. 14 is a sequence chart of commands exchanged between a registration machine and checkout machines.

FIG. 15 is a sequence chart of commands exchanged between a registration machine and checkout machines.

FIG. 16 is a sequence chart of commands exchanged between a registration machine and checkout machines.

FIG. 17 is a diagram of a transaction processing system according to a second embodiment.

FIG. 18 is a schematic diagram illustrating a data structure of a connection state table.

FIG. 19 is a sequence chart of commands exchanged between registration machines and checkout machines.

FIG. 20 is a diagram of a transaction processing system according to a third embodiment.

FIG. 21 is a schematic diagram illustrating a data structure of a connection state table.

FIG. 22 is a schematic diagram illustrating a data structure of a checkout machine state table.

FIG. 23 is a flowchart illustrating information processing executed by a processor of a registration machine.

FIG. 24 is a flowchart illustrating information processing executed by a processor of a registration machine.

FIG. 25 is a flowchart illustrating information processing executed by a processor of a checkout machine.

FIG. 26 is a flowchart illustrating information processing executed by a processor of a registration machine.

FIG. 27 is a sequence chart of commands exchanged between a registration machine and checkout machines.

FIG. 28 is a sequence chart of commands exchanged between a registration machine and checkout machines.

FIG. 29 is a sequence chart of commands exchanged between a registration machine and checkout machines.

FIG. 30 is a sequence chart of commands exchanged between a registration machine and checkout machines.

### DETAILED DESCRIPTION

An embodiment of a transaction processing system prevents settlement processing from being delayed in retail stores and the like adopting semi-self-service type systems.

In one embodiment, a transaction processing system includes an input processing device configured to generate settlement information for a transaction with a customer and a first and second settlement device. Each of the first and second settlement devices is configured to execute settlement processing for the transaction according to the settlement information generated by the input processing device. The input processing device includes a first processor configured to send the settlement information to the first settlement device as a primary transmission destination, perform a status check on the first settlement device and output a status check notification based on the status check, and change the primary transmission destination from the first settlement device to the second settlement device upon receiving a transmission change notification from the second settlement device. The second settlement device includes a second processor configured to send a status check request to the input processing device for requesting a status check on the first settlement device and send a transmission destination change to the input processing device if the status check notification output in response to the status check request includes information indicating a destination change condition has been met.

In some examples, the input processing device includes a transmitting unit, a state checking unit, and a changing unit. The transmitting unit transmits the settlement information to the one of the settlement devices (referred to as the “first settlement device” in this context) set as a transmission destination of the settlement devices. The state checking unit performs a state check (status check) on the first settlement device. Upon receiving a notification of a transmission destination change from a second settlement device of the settlement devices, the changing unit changes the transmission destination for the settlement information to the second settlement device. The second settlement device includes a status check notifying unit and a change notifying unit. The status check notifying unit sends a state check (status check response) for the first settlement device to the input processing device. If a state check response regarding the first settlement device indicates the transmission destination should be changed from the first to the second settlement device, the change notifying unit notifies the input processing device of the transmission destination change accordingly.

Certain example embodiments are explained below with reference to the drawings.

A semi-self-service type transaction processing system according to one embodiment includes an input processing device and a plurality of settlement devices. In this context, an input processing device is any device that can be used for receiving an input of data of a commodity being traded (e.g., sold or exchanged) in a transaction and then registering such data of the commodity in the transaction. The settlement device is any device for acquiring, from the input processing device, the information necessary for settlement of the transaction including, for example, the commodity sales data. The settlement device is then capable of executing settlement processing for the transaction based on the received information. In certain example embodiments explained below, the input processing device is referred to as registration machine and the settlement device is referred to as checkout machine.

### First Embodiment

### Configuration of a Transaction System

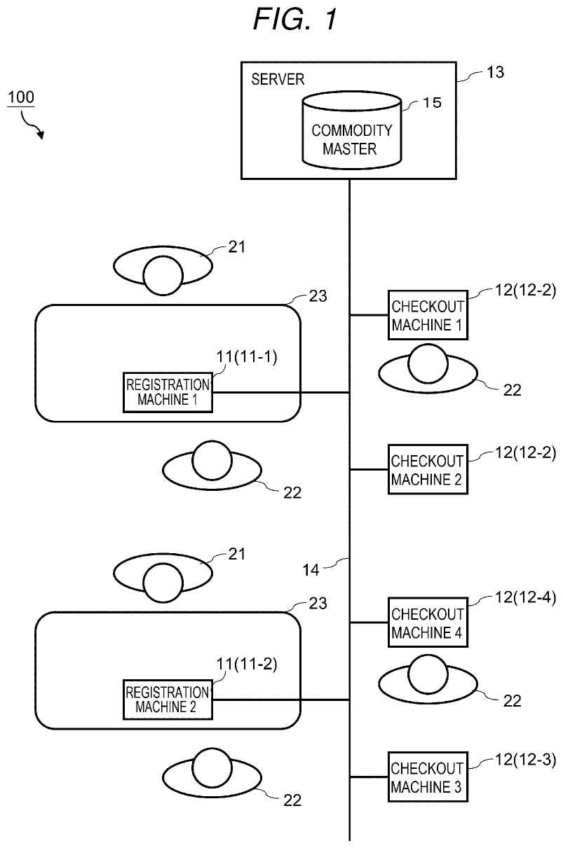

The configuration of a transaction processing system 100 according to a first embodiment is explained with reference to FIGS. 1 to 5. The configuration explained below is one, non-limiting example. Various aspects of the described configuration can be changed as appropriate if substantially the same effects can be achieved.

FIG. 1 is a schematic diagram illustrating a schematic configuration of the transaction processing system 100. The transaction processing system 100 includes registration machines 11, checkout machines 12, a server 13, and a network 14 connecting the foregoing. The type of the network 14 is not particularly limited. However, in general, a wired or wireless LAN (local area network) is applied.

Store clerks 21 playing a role called checker are operators of the registration machines 11. Consumers who purchase commodities in a store, so-called customers 22 are operators of the checkout machines 12. In FIG. 1, the registration machines 11 are attached to work tables 23. The work tables 23 include rectangular top plates. A plurality of work tables 23 are disposed such that longitudinal directions of the top plates are substantially in parallel, whereby passages for the customers 22, so-called checkout lanes are formed.

The registration machines 11 and the checkout machines 12 are disposed for each of the checkout lanes of the store. One registration machine 11 is disposed and a plurality of checkout machines 12 are disposed for one checkout lane. Various data signals are exchanged, through the network 14, between the registration machine 11 and the checkout machines 12 disposed in the same checkout lane. The data signals may be exchanged via the server 13 or may be exchanged not via the server 13.

In FIG. 1, an example is illustrated in which two registration machines 11 (11-1 and 11-2) and four checkout machines 12 (12-1, 12-2, 12-3, and 12-4) are disposed for two checkout lanes. One registration machine 11-1 of the two registration machines 11 and two checkout machines 12-1 and 12-2 among the four checkout machines 12 form a group. The other registration machine 11-2 and the remaining two checkout machines 12-3 and 12-4 form a group. The checkout machines 12 execute settlement processing for a transaction processed by the registration machine 11 in the same group. That is, the checkout machines 12-1 and 12-2 execute settlement processing for a transaction processed by the registration machine 11-1. The checkout machines 12-3 and 12-4 execute settlement processing for a transaction processed by the registration machine 11-2. The settlement processing for the transaction does not substantially differ between the different groups. Therefore, in the following explanation, the explanation focuses on the group formed by registration machine 11-1 (an input processing device) and the two checkout machines 12-1 and 12-2 Specific explanation is omitted about the group formed by the registration machine 11-2 and the two checkout machines 12-3 and 12-4 because the explanation would be redundant.

The server 13 includes a commodity master file 15. The commodity master file 15 may be saved in a storage device incorporated in the server 13 or may be saved in a storage device connected to the outside of the server 13.

The commodity master file 15 is a data file that stores a commodity record created for each of commodities sold in the store. The commodity record is a data record describing commodity data such as a commodity code, a commodity name, a unit price, and an attribute.

The commodity code is a specific code set for each of the commodities in order to identify the commodities. Usually, a barcode or a two-dimensional code representing the commodity code is attached to each of the commodities. Alternatively, an RFID (Radio Frequency Identification) tag storing the commodity code may be attached to the commodity. The registration machine 11 can input a commodity code of a commodity traded in a transaction by reading a barcode, a two-dimensional code, or an RFID tag attached to the commodity.

The commodity name and the unit price is a name of the commodity identified by the commodity code and a price per one article of the commodity. The attribute is, for example, information concerning a tax on the commodity. The information concerning the tax includes a tax rate and a tax type (an exclusive tax, an inclusive tax, or tax free).

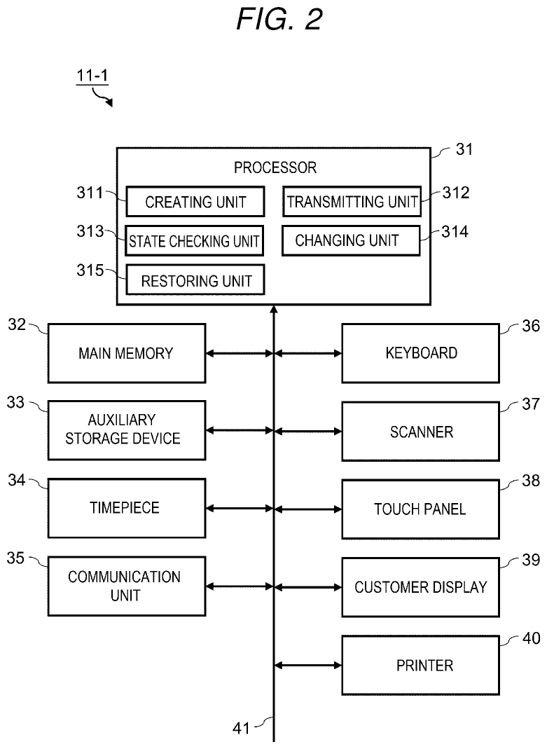

FIG. 2 is a block diagram illustrating a configuration of the registration machine 11-1. The registration machine 11-1 includes a processor 31, a main memory 32, an auxiliary storage device 33, a timepiece 34, a communication unit 35, a keyboard 36, a scanner 37, a touch panel 38, a customer display 39, a printer 40, and a system transmission line 41. The system transmission line 41 includes an address bus, a data bus, and a control signal line. The system transmission line 41 connects the processor 31 and the other units directly or via a signal input and output circuit and transmits data signals exchanged between the processor 31 and the other units.

In the registration machine 11-1, a computer including the processor 31, the main memory 32, the auxiliary storage device 33, the timepiece 34, and the communication unit 35 connected via the system transmission line 41. In the registration machine 11-1, devices such as the keyboard 36, the scanner 37, the touch panel 38, the customer display 39, and the printer 40 are also connected via the system transmission line 41.

The processor 31 controls the various units in order to realize the various functions of the registration machine 11-1 according to an operating system and/or application programs. The processor 31 is, for example, a CPU (Central Processing Unit).

The main memory 32 includes a nonvolatile memory region and a volatile memory region. The main memory 32 stores the operating system or the application programs in the nonvolatile memory region. The main memory 32 sometimes stores, in the nonvolatile or volatile memory region, data necessary for the processor 31 in executing processing for controlling the units. The main memory 32 uses the volatile memory region as a work area where data is rewritten as appropriate by the processor 31. The nonvolatile memory region is, for example, a ROM (Read Only Memory). The volatile memory region is, for example, a RAM (Random Access Memory).

For example, an EEPROM (Electric Erasable Programmable Read-Only Memory), a HDD (Hard Disk Drive), or an SSD (Solid-State Drive) can be the auxiliary storage device 33. The auxiliary storage device 33 saves data used by the processor 31 in executing various kinds of processing, data created by the processing in the processor 31, and the like. The auxiliary storage device 33 sometimes stores application programs.

The timepiece 34 clocks a date and time. The processor 31 processes, as the present date and time, the date and the time clocked by the timepiece 34.

The communication unit 35 performs data communication between the server 13 and the checkout machines 12-1 and 12-2 connected via the network 14. The communication unit 35 can also perform data communication with the registration machine 11-2 and the checkout machine 12-3 or the checkout machine 12-4 in the other group, which is also connected via the network 14.

The keyboard 36 is an input device on which various keys necessary for, for example, an input of data relating to a commodity purchased by a customer are disposed.

The scanner 37 is an example of a reading device capable of reading a code symbol such as a barcode or a two-dimensional code. The scanner 37 may be a type for reading the code symbol with laser light scanning or may be a type for reading the code symbol from an image captured by an imaging device.

The touch panel 38 is equipment including both of an input device and a display device. The touch panel 38 displays information to a store clerk, who is an operator of the registration machine 11-1, and receives an operation input by the store clerk.

The customer display 39 displays information to the customer 22.

The printer 40 dispenses a receipt by printing various character strings, images, or the like on receipt paper. As the printer 40 of this type, for example, a thermal printer or a dot impact printer can be used.

As hardware of such a registration machine 11-1, for example, the existing POS terminal can be used. Devices connected to the registration machine 11-1 are not limited to the keyboard 36, the scanner 37, the touch panel 38, the customer display 39, and the printer 40 illustrated in FIG. 2. Devices necessary in a use of the registration machine 11-1 may be added or a part of the devices may be omitted.

In the registration machine 11-1, the processor 31 provides the described functions of a creating unit 311, a transmitting unit 312, a state checking unit 313, a changing unit 314, and a restoring unit 315. The creating unit 311 provides a function of creating settlement information necessary for settlement of a transaction with the customer 22 based on data relating to a commodity input via the reading device or the input device. The transmitting unit 312 provides a function of transmitting the settlement information to the checkout machine 12 set as a transmission destination from among the two checkout machines 12-1 and 12-2.

The settlement information includes items such as a transaction number, a transaction date and time, a terminal ID, commodity sales data, a total number of articles, and a total amount. The transaction number is a serial number given for each of transactions with the customer 22 in order to individually identify the transactions. The transaction date and time is a date and time when the transaction was performed. The terminal ID is identification information set in the registration machine 11-1 that processed the transaction. Specific terminal IDs are set in advance in the registration machines 11 (11-1, 11-2, . . . ). Specific terminal IDs can also be set in the checkout machines 12 (12-1, 12-1, 12-3, 12-4, . . . ) as well. The commodity sales data includes items such as a commodity code, a commodity name, a unit price, the number of sold articles, a sales amount, and an attribute of a commodity purchased by the customer 22. The settlement information includes commodity sales data of all commodities purchased by the customer 22 in the transaction. The total number of articles is a value obtained by adding up the numbers of sold articles of commodity sales data in one transaction. The total amount is an amount obtained by adding up sales amounts of the commodity sales data in one transaction.

Such settlement information is uniquely specified by the transaction number, the transaction date and time, and the terminal ID. That is, the transaction number, the transaction date and time, and the terminal ID function as transaction specifying information capable of specifying the settlement information. The settlement specifying information is not limited to the transaction number, the transaction date and time, and the terminal ID. If the settlement information can be specified, other items may be added or a part of the items may be omitted. A data structure of the settlement information is not limited to the items described above. Other items may be added or a part of the items may be omitted.

The state checking unit 313 provides a function of performing a state check for the one checkout machine set as a transmission destination from among the two checkout machines 12-1 and 12-2. The processor 31 receives a state check notification from any one of the checkout machines and performs a state check for the one checkout machine set as the transmission destination. The processor 31 returns information indicating a state check result of the checkout machine to the checkout machine at the notification source as a response. The processor 31 may perform the state check for the one checkout machine set as the transmission destination asynchronously with the state check notification from the checkout machine. The changing unit 314 provides a function of, upon receiving a notification of a transmission destination change from the other checkout machine (the one not presently set as the transmission destination) of the two checkout machines 12-1 and 12-2, changing the transmission destination of the settlement information to the other checkout machine. The restoring unit 315 provides a function of resetting the transmission destination of the settlement information to the first checkout machine if the transmission destination of the settlement information is presently the second checkout machine when a notification for a transmission destination change is received from the first checkout machine.

All of the functions of the creating unit 311, the transmitting unit 312, the state checking unit 313, the changing unit 314, and the restoring unit 315 are realized in this example by first information processing, second information processing, and/or third information processing executed by the processor 31 according to a registration program. The first information processing, the second information processing, and the third information processing are explained below.

The registration program can be one of the application programs stored in the main memory 32 or the auxiliary storage device 33. A method of installing the registration program in the main memory 32 or the auxiliary storage device 33 is not particularly limited. The registration program can be installed in the main memory 32 or the auxiliary storage device 33 by being recorded in a removable recording medium or being distributed by communication via the network 14. A form of the recording medium does not matter if the recording medium can store a program and can be read by a device like a CD-ROM, a memory card, or the like.

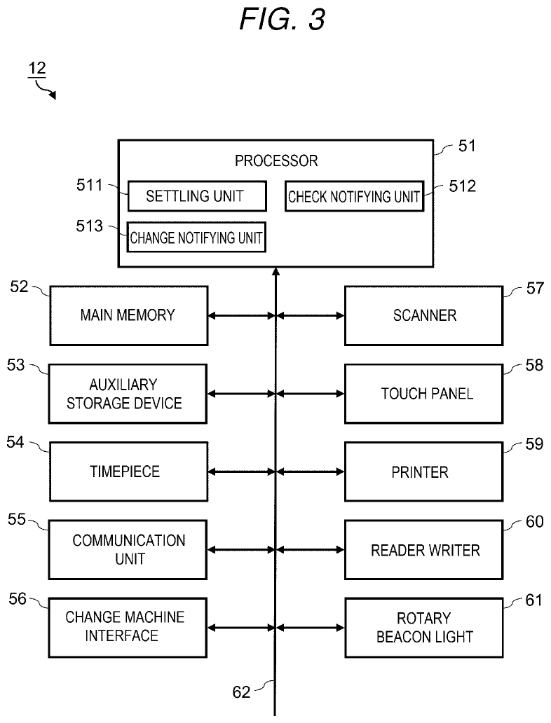

FIG. 3 is a block diagram illustrating a configuration of the checkout machine 12. One checkout machine 12-1 and the other checkout machine 12-2 have substantially the same hardware configuration. Therefore, in FIG. 3, one checkout machine 12-1 and the other checkout machine 12-2 are not distinguished and explained as the checkout machine 12.

The checkout machine 12 includes a processor 51, a main memory 52, an auxiliary storage device 53, a timepiece 54, a communication unit 55, a change machine interface 56, a scanner 57, a touch panel 58, a printer 59, a reader writer 60, a rotary beacon light 61, and a system transmission line 62. The system transmission line 62 includes an address bus, a data bus, and a control signal line. The system transmission line 62 connects the processor 51 and the other units directly or via a signal input and output circuit and transmits data signals exchanged between the processor 51 and the other units.

In the checkout machine 12, a computer including the processor 51, the main memory 52, the auxiliary storage device 53, the timepiece 54, and the communication unit 55 connected via the system transmission line 62. In the checkout machine 12, device interfaces or devices such as the change machine interface 56, the scanner 57, the touch panel 58, the printer 59, the reader writer 60, and the rotary beacon light 61 are also connected to via the system transmission line 62.

The processor 51 controls the various units in order to realize the various functions of the checkout machine 12 according to an operating system and/or application programs. The processor 51 is, for example, a CPU.

The main memory 52 includes a nonvolatile memory region and a volatile memory region. The main memory 52 stores the operating system or the application programs in the nonvolatile memory region. The main memory 52 sometimes stores, in the nonvolatile or volatile memory region, data necessary for the processor 51 for executing processing for controlling the units. The main memory 52 uses the volatile memory region as a work area where data is rewritten as appropriate by the processor 51. The nonvolatile memory region is, for example, a ROM. The volatile memory region is, for example, a RAM.

For example, an EEPROM, a HDD, an SSD, or the like can be the auxiliary storage device 53. The auxiliary storage device 53 saves data used by the processor 51 in preforming various kinds of processing, data created by the processing in the processor 51, and the like. The auxiliary storage device 53 sometimes stores application programs.

The timepiece 54 tracks a date and time. The date and time tracked by the timepiece 54 is taken as the present date and time by the processor 51.

The communication unit 55 performs data communication with the server 13 connected via the network 14 or the registration machine 11-1 in the same checkout lane. The communication unit 55 can also perform data communication with the registration machine 11-2 or the checkout machines 12-3 and 12-4 in the other group connected via the network 14.

The change machine interface 56 provides an interface to an automatic change machine. The change machine interface 56 receives, from the automatic change machine, an input of amount data of money deposited to the automatic change machine. The change machine interface 56 outputs change data from the checkout machine 12 to the automatic change machine. The automatic change machine automatically dispenses money equivalent to the change data as change.

The scanner 57 is an example of a reading device that reads a code symbol such as a barcode or a two-dimensional code. The scanner 57 may be a type for reading the code symbol with laser light scanning or may be a type for reading the code symbol from an image captured by an imaging device.

The touch panel 58 is equipment including both of an input device and a display device. The touch panel 58 displays information to the customer 22, who is an operator of the checkout machine 12, and receives an operation input by the customer 22.

The printer 59 dispenses a receipt by printing various character strings, images, or the like on receipt paper. As the printer 59 of this type, for example, a thermal printer or a dot impact printer can be used.

The reader writer 60 has a function of reading data recorded in a medium such as a card or a smartphone and a function of writing data in the medium. The card can include, besides a card for settlement such as a credit card, a debit card, an electronic money card, or a prepaid card, a member card called a member's card or a point card. The reader writer 60 may be a device of a magnetic type, a contact type, or a noncontact type or may include a plurality of types of devices.

The rotary beacon light 61 includes, for example, light emitting bodies of two colors of red and blue. The rotary beacon light 61 is associated with the checkout machine 12 and provided at the top of a pole erected near the checkout machine 12. The rotary beacon light 61 is lit or flashed in, for example, red or blue according to a state of the checkout machine 12 corresponding to the rotary beacon light 61.

As hardware of such a checkout machine 12, for example, a POS terminal in the existing full-self-service type transaction processing system, a so-called self-service register can be used. Devices connected to the checkout machine 12 are not limited to the scanner 57, the touch panel 58, the printer 59, the reader writer 60, and the rotary beacon light 61 illustrated in FIG. 3. Devices necessary in a use of the checkout machine 12 may be added or a part of the devices may be omitted.

In the checkout machine 12, the processor 51 provides the described functions of a settling unit 511, a check notifying unit 512, and a change notifying unit 513. The settling unit 511 provides a function of executing settlement processing based on settlement information.

The check notifying unit 512 provides a function of notifying a state check for a checkout machine 12 to the registration machine 11-1 of the same group. For example, after a system start, the processor 51 sends a state check for the checkout machines 12 to the registration machine 11-1 periodically at an interval of a monitoring time set in a monitoring timer. In some examples, the processor 51 may send the state check for the checkout machines 12 to the registration machine 11-1 each time settlement processing for a transaction ends.

The change notifying unit 513 provides a function of notifying (sending) a transmission destination change to the registration machine 11-1 if a state check satisfies a transmission destination change condition. The transmission destination change condition is explained below.

All of the functions of the settling unit 511, the check notifying unit 512, and the change notifying unit 513 are realized by fourth information processing, fifth information processing, sixth information processing, and seventh information processing executed by the processor 51 according to a settlement program in this example. The fourth information processing to the seventh information processing are explained below.

The settlement program can be one of the application programs stored in the main memory 52 or the auxiliary storage device 53. The method of installing the settlement program in the main memory 52 or the auxiliary storage device 53 is not particularly limited. The settlement program can be installed in the main memory 52 or the auxiliary storage device 53 by being recorded in a removable recording medium or being distributed by communication via the network 14. A form of the recording medium does not matter if the recording medium can store a program and can be read by a device like a CD-ROM, a memory card, or the like.

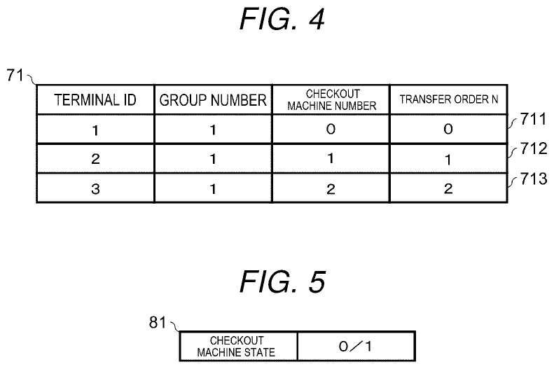

FIG. 4 is a schematic diagram illustrating a main data structure of a connection state table 71 included in each of the registration machine 11-1 and the checkout machines 12-1 and 12-2 forming the same group. The connection state table 71 is stored in, for example, the auxiliary storage devices 33 and 53. The registration machine 11-1 and the checkout machines 12-1 and 12-2 include a connection state table 71 having the same content.

As illustrated in FIG. 4, the connection state table 71 includes data records 711, 712, and 713 formed by individual elements such as a terminal ID, a group number, a checkout machine number, and transfer order N. The data record 711 is a data record concerning the registration machine 11-1. The data record 712 is a data record concerning one checkout machine 12-1. The data record 713 is a data record concerning the other checkout machine 12-2.

The terminal ID is specific identification information respectively set for terminals such as the registration machine 11-1, the checkout machine 12-1, and the checkout machine 12-2. Different terminal IDs are respectively set in at least the registration machine 11 and the checkout machine 12 incorporated in the transaction processing system 100.

The group number is a number set for each of groups in order to identify a group formed by one registration machine 11 and two checkout machines 12. Therefore, a group number of the connection state table 71 for one group is common. The group number may be a serial number or may not be the serial number. The group number only has to not overlap at least a group number of another group.

The checkout machine number is a serial number from “1” set for each of checkout machines in order to individually identify the two checkout machines 12-1 and 12-2 forming the same group. “0” is set as the checkout machine number for the registration machine 11-1 forming the same group.

The transfer order N is a serial number from “1” indicating transfer order to the two checkout machines 12-1 and 12-2 of settlement information transmitted from the registration machine 11-1 forming the same group. In this embodiment, the transfer order N of the checkout machine 12-1 having the checkout machine number “1” is set as first place and the transfer order N of the checkout machine 12-2 having the checkout machine number “2” is set as second place. The transfer order N of the checkout machine 12-2 having the checkout machine number “2” may be set as first place and the transfer order N of the checkout machine 12-1 having the checkout machine number “1” may be set as second place. “0” is set as the transfer order N for the registration machine 11-1. In the following explanation, for convenience of explanation, the checkout machine 12-1 having the checkout machine number “1” is referred to as first checkout machine 12-1 and the checkout machine 12-2 having the checkout machine number “2” is referred to as second checkout machine 12-2. The first checkout machine 12-1 can also be referred to as a master, a master machine, a primary machine, or the like because the transfer order N thereof is the first place. The second checkout machine 12-2 can also be referred to as a slave, a satellite machine, a secondary machine, or the like because the transfer order N thereof is the second place (after the first place).

FIG. 5 is a schematic diagram illustrating a checkout machine state flag 81 included in the registration machine 11-1. The checkout machine state flag 81 is stored in, for example, the volatile memory region of the main memory 32. The checkout machine state flag 81 is a region for storing a value capable of discriminating whether the first checkout machine 12-1, the transfer order N of which is first place, is set as a transmission destination of settlement information. The value is 1-bit data of “0” or “1”. In this embodiment, a value of the checkout machine state flag 81 at the time when the first checkout machine 12-1 is set as the transmission destination of the settlement information is set to “0”. A value of the checkout machine state flag 81 at the time when the first checkout machine 12-1 is not set as the transmission destination of the settlement information is set to “1”. The value of the checkout machine state flag 81 at the time when the first checkout machine 12-1 is set as the transmission destination of the settlement information may be set to “1”. The value of the checkout machine state flag 81 at the time when the first checkout machine 12-1 is not set as the transmission destination of the settlement information may be set to “0”.

### Functions of the Transaction Processing System

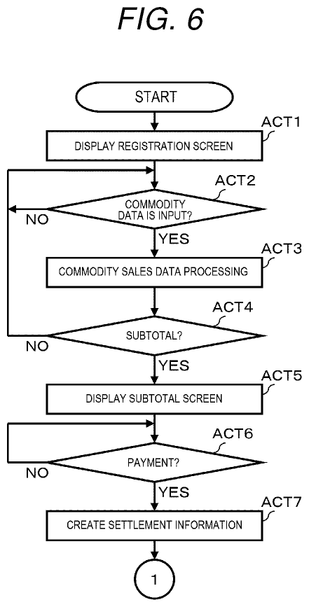

Main functions of the transaction processing system 100 are explained with reference to FIGS. 6 to 16. Processing and procedures relating to the functions explained below are examples. Contents of the procedures or the processing can be changed as appropriate if the same effects can be achieved.

First, a first function relating to settlement of a transaction is explained. In the registration machine 11-1, the functions of the creating unit 311 and the transmitting unit 312 relate to the first function. In the first checkout machine 12-1 and the second checkout machine 12-2, the function of the settling unit 511 relates to the first function. The functions of the creating unit 311 and the transmitting unit 312 are based on the first information processing. The function of the settling unit 511 is based on the fourth information processing or the fifth information processing.

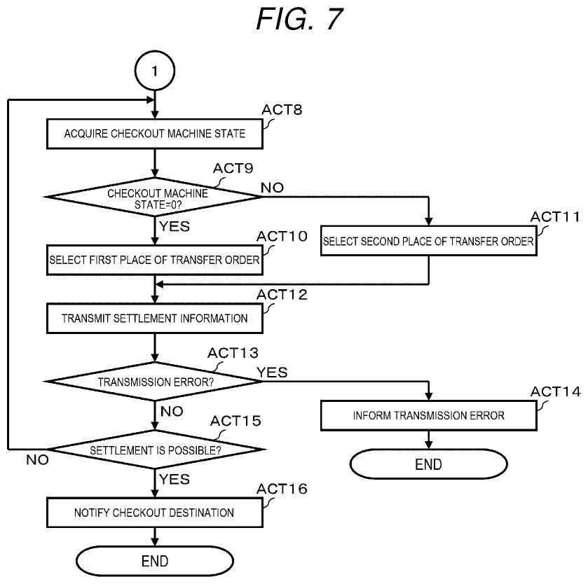

FIGS. 6 and 7 are flowcharts illustrating a procedure of the first information processing executed by the processor 31 of the registration machine 11-1 according to the registration program. The customer 22 puts a commodity that the customer 22 purchases out of commodities displayed in a selling floor in a shopping basket or the like and moves to the checkout lane. If the customer 22 comes to the checkout lane, the store clerk 21 playing a role of a checker performs declaration operation for a registration start on the registration machine 11-1. According to the operation, the registration program of the registration machine 11-1 starts. The processor 31 starts the first information processing, the procedure of which is illustrated in the flowcharts of FIGS. 6 and 7.

In ACT 1, the processor 31 causes the touch panel 38 to display a registration screen. The registration screen is a screen on which, for example, a detail region and a total region are arranged and a subtotal button is further arranged. The detail region is a region for displaying a commodity name, the number of articles, a unit price, and an amount in a list format in the order of a series of numbers. The total region is a region for respectively displaying a total (number of articles) of the numbers of articles and a total (yen) of amounts displayed in the detail region. The subtotal button is an operator that the store clerk 21 touches in order to instruct a subtotal output of a commodity purchased by the customer 22.

In ACT 2, the processor 31, which controlled the display of the registration screen, waits for data relating to a commodity to be input. To most commodities, barcodes representing commodity codes, which are identification information of the commodities, are attached. Therefore, the store clerk 21 operates the scanner 37 to read a barcode attached to a purchased commodity of the customer 22. The barcode is read by the scanner 37, whereby a commodity code of the purchased commodity is input to the registration machine 11-1. On the other hand, a barcode is sometimes not attached to a part of commodities such as perishables. If a barcode is not attached to the purchased commodity, the store clerk 21 touches a commodity button corresponding to the purchased commodity out of a commodity button group displayed on the touch panel 38. If the commodity button is touched, a commodity code of a commodity corresponding to the commodity button is input to the registration machine 11-1.

If the commodity code is input, the processor 31 proceeds to YES in ACT 2. In ACT 3, the processor 31 executes commodity sales data processing. That is, the processor 31 acquires commodity data such as a commodity name, a unit price, and an attribute from a commodity record of the commodity identified by the commodity code input via the scanner 37 or the touch panel 38. The processor 31 registers, in a transaction memory, commodity sales data including items such as a commodity code, a commodity name, a unit price, the number of sold articles, a sales amount, and an attribute. The transaction memory is a part of the volatile memory region in the main memory 32.

In ACT 4, the processor 31, which finished the commodity sales data processing, checks whether the subtotal button is touched. The store clerk 21 sequentially performs operation for inputting the commodity code of the purchased commodity of the customer 22. If finishing inputting commodity codes of all purchased commodities, the store clerk 21 touches the subtotal button.

If the subtotal button is not touched and a commodity code of the next commodity is input, the processor 31 proceeds to NO in ACT 4 and further proceeds to YES in ACT 2. That is, in ACT 3, the processor 31 executes the commodity sales data processing. As a result, commodity sales data of the purchased commodity is registered in the transaction memory.

If the subtotal button is touched, the processor 31 proceeds to YES in ACT 4. In ACT 5, the processor 31 causes the touch panel 38 to display a subtotal screen. The subtotal screen is a screen on which a total region is arranged and a payment button and the like are further arranged. The total region is the same as the total region of the registration screen. The payment button is an operator that the store clerk 21 touches in order to instruct payment of a price. The store clerk 21 checks the subtotal screen and touches the payment button.

In ACT 6, the processor 31, which controls the display of the subtotal screen, waits for the payment button to be touched. If the payment button is touched by the store clerk 21, the processor 31 proceeds to YES in ACT 6. In ACT 7, the processor 31 creates settlement information. That is, the processor 31 creates settlement information necessary for settlement of a transaction using commodity sales data of purchased commodities and total numbers of articles and data of a total amount of the purchased commodities registered in the transaction memory and transaction specifying data such as a transaction number, a transaction date and time, and a terminal ID of a registration machine.

If finishing creating the settlement information, the processor 31 proceeds to ACT 8 in FIG. 7. In ACT 8, the processor 31 acquires the checkout machine state flag 81. In ACT 9, the processor 31 checks whether a value of the checkout machine state flag 81 is “0” or “1”.

If the value of the checkout machine state flag 81 is “0”, that is, the first checkout machine 12-1 is set as a transmission destination of the settlement information, the processor 31 proceeds to YES in ACT 9. In ACT 10, the processor 31 refers to the connection state table 71 and selects a terminal ID of the first checkout machine 12-1, the transfer order N of which is set to the first place.

If the value of the checkout machine state flag 81 is “1”, that is, the first checkout machine 12-1 is not set as the transmission destination of the settlement information, the processor 31 proceeds to NO in ACT 9. In ACT 11, the processor 31 refers to the connection state table 71 and selects a terminal ID of the second checkout machine 12-2, the transfer order N of which is set to the second place.

If finishing the processing in ACT 10 or ACT 11, the processor 31 proceeds to ACT 12. In ACT 12, the processor 31 controls the communication unit 35 to transmit the settlement information with a checkout machine specified by the terminal ID acquired in the processing in ACT 10 or ACT 11 set as a transmission destination. According to the control, if the terminal ID of the first checkout machine 12-1 is selected in ACT 10, the settlement information is transmitted to the network 14 with the first checkout machine 12-1 set as the transmission destination. If the terminal ID of the second checkout machine 12-2 is selected in ACT 11, the settlement information is transmitted to the network 14 with the second checkout machine 12-2 set as the transmission destination.

In ACT 13, the processor 31, which controlled the transmission of the settlement information, checks whether a transmission error occurs. For example, if the checkout machine 12 at the transmission destination is broken down or a communication failure occurs in the network 14, an error occurs in the transmission of the settlement information. If the error occurs in the transmission of the settlement information, the processor 31 proceeds to YES in ACT 13. In ACT 14, the processor 31 informs the transmission error of the settlement information. For example, the processor 31 causes the touch panel 38 to display a message of the transmission error and informs the transmission error.

If an error does not occur in the transmission of the settlement information, the processor 31 proceeds to YES in ACT 13. In ACT 15, the processor 31 checks whether a settleability notification command is received from the checkout machine 12. Incidentally, if the settlement information is transmitted to the checkout machine 12-1 or 12-2, the settleability notification command or a busy notification command is returned from one of the checkout machines 12.

If receiving the busy notification command rather than the settleability notification command, the processor 31 proceeds to NO in ACT 15 and returns to ACT 8. The processor 31 executes the processing in ACT 8 and subsequent acts in the same manner as explained above.

If receiving the settleability notification command, the processor 31 proceeds to YES in ACT 15. In ACT 16, the processor 31 notifies a checkout machine at a checkout destination. That is, if a transmission source of the settleability notification command is the first checkout machine 12-1, the processor 31 notifies that the first checkout machine 12-1 is the checkout destination. If the transmission source of the settleability notification command is the second checkout machine 12-2, the processor 31 notifies that the second checkout machine 12-2 is the checkout destination. The notification may be made to the store clerk 21 using the touch panel 38 or may be made to the customer 22 using the customer display 39. The customer 22 moves to a setting place of the first checkout machine 12-1 or the second checkout machine 12-2 notified as the checkout destination, operates the checkout machine 12, and performs checkout by himself or herself.

Then, the processor 31 ends the first information processing.

The processor 31 of the registration machine 11-1 realizes the function of the creating unit 311 with the processing in ACT 7. The processor 31 realizes the function of the transmitting unit 312 with the processing in ACT 8 or ACT 12.

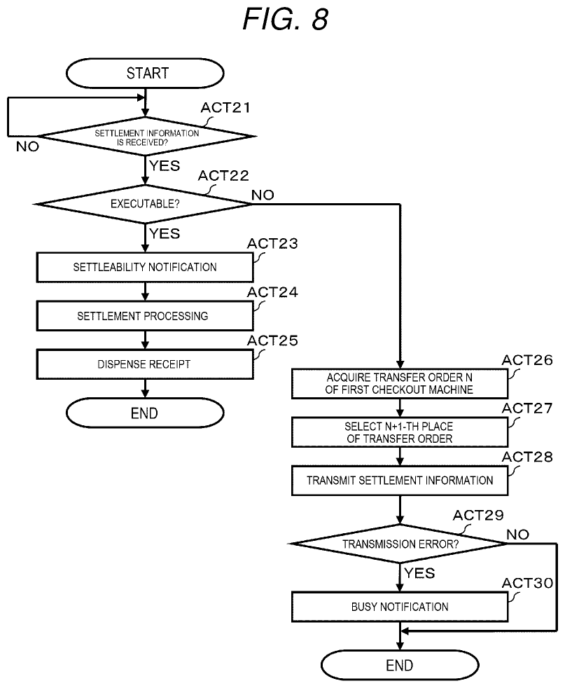

FIG. 8 is a flowchart illustrating a procedure of the fourth information processing executed by the processor 51 of the first checkout machine 12-1 according to the settlement program. In ACT 21, the processor 51 is waiting for settlement information. If settlement information transmitted from the registration machine 11-1 is received by the communication unit 55, the processor 51 proceeds to YES in ACT 21. In ACT 22, the processor 51 checks whether the first checkout machine 12-1 is capable of executing settlement processing. For example, if settlement processing for the preceding customer does not end, the first checkout machine 12-1 cannot execute settlement processing for the next customer. If a printer error such as paper clogging or paper running-out in the printer 59 or a change machine error such as money clogging or change running-out in the change machine is occurring, the first checkout machine 12-1 cannot execute the settlement processing.

If the first checkout machine 12-1 is capable of executing the settlement processing, the processor 51 proceeds to YES in ACT 22. In ACT 23, the processor 51 controls the communication unit 55 to transmit a settleability notification command to the registration machine 11-1. According to the control, the settleability notification command is transmitted to the registration machine 11-1.

In ACT 24, the processor 51 executes settlement processing. Specifically, the processor 51 sets a screen of the touch panel 58 as a payment method selection screen. The payment method selection screen is, for example, a screen on which operators for selecting a payment method such as a cash button, a credit button, and an electronic money button are arranged. A customer moving to the setting place of the first checkout machine 12-1 touches a button corresponding to a desired payment method. That is, a customer desiring cash payment touches the cash button. A customer desiring credit card payment touches the credit button. A customer desiring electronic money payment touches the electronic money button.

The processor 51, which controlled the display of the payment method selection screen, waits for any one of the payment methods to be selected. If a payment method is selected, the processor 51 executes settlement processing corresponding to the payment method. For example, if the cash payment is selected as the payment method, the processor 51 executes processing for deducting a total amount from an amount deposited to the automatic change machine, calculating change, and dispensing the change from the automatic change machine. For example, if the credit card payment is selected as the payment method, the processor 51 authenticates a credit card read by the reader writer 60 and decides the total amount as a credit settlement amount on condition that the credit card payment is approved by the server 13. For example, if the electronic money payment is selected as the payment method, the processor 51 deducts the total amount from the balance of an electronic money medium read by the reader writer 60.

If the settlement processing for each of the payment methods ends in this way, in ACT 25, the processor 51 controls the printer 59 to dispense a transaction receipt. On the transaction receipt, settlement information, that is, a transaction number, a transaction date and time, a terminal ID, commodity sales data, a total number of articles, a total amount, and the like are printed.

On the other hand, if the first checkout machine 12-1 is incapable of executing the settlement processing, the processor 51 proceeds to NO in ACT 22. In ACT 26, the processor 51 refers to the connection state table 71 and acquires the transfer order N correlated with the terminal ID of the first checkout machine 12-1. Subsequently, in ACT 27, the processor 51 selects the other checkout machine 12-2, as the transfer order N of which, order obtained by adding “1” to the transfer order N is set. In ACT 28, the processor 51 controls the communication unit 55 to transmit the settlement information with the selected other checkout machine 12-2 set as a destination. According to the control, the settlement information is transmitted (transferred) to the network 14 with the second checkout machine 12-2, the transfer order N of which is the second place, set as a transmission destination.

In ACT 29, the processor 51, which controlled the transmission (the transfer) of the settlement information, checks whether a transmission error occurs. For example, if the checkout machine 12-2 at the transmission destination is broken down, an error occurs in the transmission of the settlement information. If the error occurs in the transmission of the settlement information, the processor 51 proceeds to YES in ACT 29. In ACT 30, the processor 51 controls the communication unit 55 to transmit a busy notification command to the registration machine 11-1. According to the control, the busy notification command is transmitted to the registration machine 11-1.

Then, the processor 51 ends the fourth information processing.

The processor 51 of the first checkout machine 12-1 realizes the function of the settling unit 511 with the processing in ACT 24. The processor 51 of the first checkout machine 12-1 realizes a function of a transferring unit with the processing in ACT 25 to ACT 27.

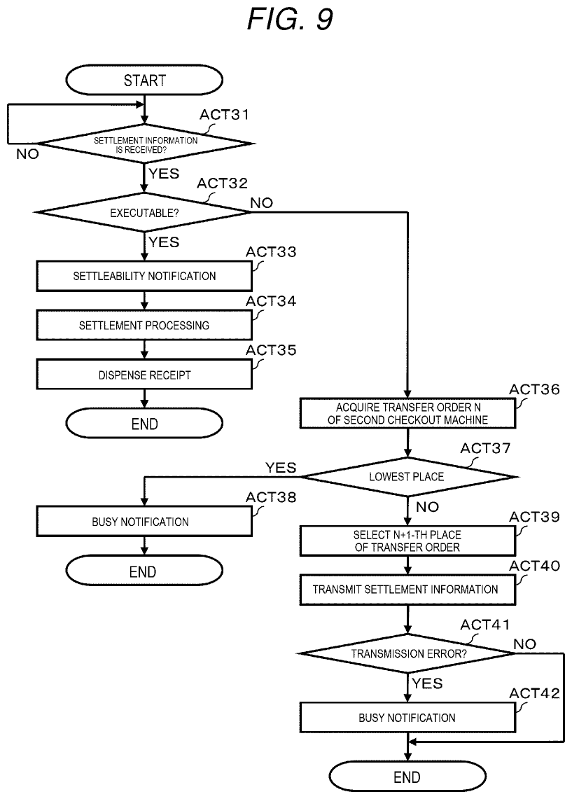

FIG. 9 is a flowchart illustrating a procedure of the fifth information processing executed by the processor 51 of the second checkout machine 12-2 according to the settlement program. In ACT 31, the processor 51 is waiting for settlement information. If the settlement information transmitted from the first checkout machine 12-1 is received by the communication unit 55, the processor 51 proceeds to YES in ACT 31. In ACT 32, the processor 51 checks whether the second checkout machine 12-2 is capable of executing settlement processing. For example, if settlement processing for the preceding customer does not end, the second checkout machine 12-2 cannot execute settlement processing for the next customer. If a printer error such as paper clogging or paper running-out in the printer 59 or a change machine error such as money clogging or change running-out in the change machine is occurring, the second checkout machine 12-2 cannot execute the settlement processing.

If the second checkout machine 12-2 is capable of executing the settlement processing, the processor 51 proceeds to YES in ACT 32. In ACT 33 to ACT 35, the processor 51 executes the same processing as the processing in ACT 23 to ACT 25 in FIG. 8. That is, in ACT 33, the processor 51 controls the communication unit 55 to transmit a settleability notification command to the registration machine 11-1. In ACT 34, the processor 51 executes the settlement processing. Thereafter, in ACT 35, the processor 51 controls the printer 59 and dispenses a transaction receipt.

On the other hand, if the second checkout machine 12-2 is incapable of executing the settlement processing, the processor 51 proceeds to NO in ACT 32. In ACT 36, the processor 51 refers to the connection state table 71 and acquires the transfer order N correlated with the terminal ID of the second checkout machine 12-2. In ACT 37, the processor 51 checks whether the transfer order N is the lowest place in the transfer order N of records described in the connection state table 71.

If two checkout machines 12 belong to a group, the transfer order N set in the second checkout machine 12-2, that is, the second place is the lowest place. If the transfer order N is the lowest place, the processor 51 proceeds to YES in ACT 37. In ACT 38, the processor 51 controls the communication unit 55 to transmit a busy notification command to the registration machine 11-1. According to the control, the busy notification command is transmitted to the registration machine 11-1.

If three or more checkout machines 12 belong to a group, the transfer order N set in the second checkout machine 12-2 is not the lowest place. If the transfer order N is not the lowest place, the processor 51 proceeds to NO in ACT 37. In ACT 39, the processor 51 selects another checkout machine 12, as the transfer order N of which, order obtained by adding “1” to the transfer order N is set. In ACT 40, the processor 51 controls the communication unit 55 to transmit settlement information with the selected other checkout machine 12 set as a destination. According to the control, the settlement information is transmitted (transferred) to the network 14 with the checkout machine 12 lower in the transfer order N set as a transmission destination.

In ACT 41, the processor 51, which controlled the transmission (the transfer) of the settlement information, checks whether a transmission error occurs. If an error occurs in the transmission of the settlement information, the processor 51 proceeds to YES in ACT 41. In ACT 42, the processor 51 controls the communication unit 55 to transmit a busy notification command to the registration machine 11-1. According to the control, the busy notification command is transmitted to the registration machine 11-1.

Then, the processor 51 ends the fifth information processing.

The processor 51 of the second checkout machine 12-2 realizes the function of the settling unit 511 with the processing in ACT 34. The processor 51 of the second checkout machine 12-2 realizes the function of the transferring unit with the processing in ACT 36 to ACT 40.

As it is evident from the explanation of the first function, if the registration machine 11-1 sets the first checkout machine 12-1 as the transmission destination of the settlement information, that is, if the value of the checkout machine state flag 81 is “0”, the settlement information created by the registration machine 11-1 is transmitted to the first checkout machine 12-1. At this time, if the first checkout machine 12-1 can execute the settlement processing, the settleability notification command is transmitted from the first checkout machine 12-1 to the registration machine 11-1. Consequently, the store clerk 21 at the registration machine 11-1 can instruct the customer 22 to perform checkout in the first checkout machine 12-1. The customer 22 moves to the setting place of the first checkout machine 12-1 and performs operation for checkout by himself or herself. In response to the operation, the first checkout machine 12-1 executes the settlement processing.

On the other hand, if the first checkout machine 12-1 cannot execute the settlement processing, the settlement information is transferred from the first checkout machine 12-1 to the second checkout machine 12-2. At this time, if the second checkout machine 12-2 can execute the settlement processing, the settleability notification command is transmitted from the second checkout machine 12-2 to the registration machine 11-1. Consequently, the store clerk 21 at the registration machine 11-1 can instruct the customer 22 to perform checkout in the second checkout machine 12-2. The customer 22 moves to a setting place of the second checkout machine 12-2 and performs operation for checkout by himself or herself. In response to the operation, the second checkout machine 12-2 executes the settlement processing.

In this way, if at least one of the first checkout machine 12-1 and the second checkout machine 12-2 can execute the settlement processing, the transaction processing system 100 can settle a transaction with the customer 22.

However, if the settlement information is transmitted (transferred) from the first checkout machine 12-1 to the second checkout machine 12-2 but the second checkout machine 12-2 also cannot execute the settlement processing, the busy notification command is transmitted from the second checkout machine 12-2 to the registration machine 11-1. For example, if the second checkout machine 12-2 is broken down and an error occur in the transmission of the settlement information to the second checkout machine 12-2, the busy notification command is transmitted from the first checkout machine 12-1 to the registration machine 11-1. The registration machine 11-1 receives the busy notification command and transmits the settlement information to the first checkout machine 12-1 again. Therefore, for example, when settlement of the preceding customer ends and the settlement processing with the first checkout machine 12-1 becomes available again, the transaction processing system 100 can still settle the transaction with the customer 22 though somewhat delayed.

However, if the settlement information cannot be transmitted from the registration machine 11-1 to the first checkout machine 12-1 because the first checkout machine 12-1 is broken down, then even if the second checkout machine 12-2 is normally operating, the settlement information can not be transmitted (transferred) to the second checkout machine 12-2 by the first checkout machine 12-1. Accordingly, the transaction processing system 100 cannot settle the transaction with the customer 22 even though at least one checkout machine 12 remains available.

Therefore, a second function included in the transaction processing system 100 is provided in order to solve such a potential deficiency found in conventional systems. In the registration machine 11-1, the functions of the state checking unit 313, the changing unit 314, and the restoring unit 315 relate to this second function. In the first checkout machine 12-1 and the second checkout machine 12-2, the functions of the check notifying unit 512 and the change notifying unit 513 also relate to the second function. The function of the state checking unit 313 is based on the second information processing. The functions of the changing unit 314 and the restoring unit 315 are based on the third information processing. The function of the check notifying unit 512 is based on the sixth information processing. The function of the change notifying unit 513 is based on the seventh information processing.

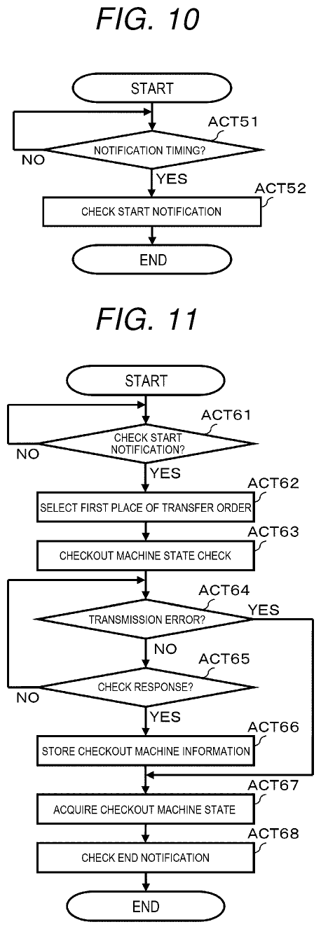

FIG. 10 is a flowchart illustrating a procedure of the sixth information processing executed by the processor 51 of the first checkout machine 12-1 and the second checkout machine 12-2 according to the settlement program. In ACT 51, the processor 51 checks whether it is a notification timing for a checkout machine check notification. After the first checkout machine 12-1 and the second checkout machine 12-2 are started in a checkout machine mode, the processor 51 starts a monitoring timer or the like. Every time a count value of the monitoring timer reaches a set value, the processor 51 proceeds to YES in ACT 51. In ACT 52, the processor 51 controls the communication unit 55 to transmit a check start notification command to the registration machine 11-1. According to the control, the check start notification command is transmitted to the registration machine 11-1.

Then, the processor 51 ends the sixth information processing.

In this way, the first checkout machine 12-1 and the second checkout machine 12-2 in normal operation periodically transmit a check start notification command to the registration machine 11-1 at a time interval corresponding to the set value of the monitoring timer. The set value of the monitoring timer is arbitrary. For example, the appropriate value can be set by an administrator of the system.

The processors 51 of the first checkout machine 12-1 and the second checkout machine 12-2 each realize the function of the check notifying unit 512 with the processing in ACT 51 and ACT 52.

FIG. 11 is a flowchart illustrating a procedure of the second information processing executed by the processor 31 of the registration machine 11-1 according to the registration program. In ACT 61, the processor 31 waits for the check start notification command. If receiving the check start notification command via the communication unit 35, the processor 31 proceeds to YES in ACT 61. In ACT 62, the processor 31 refers to the connection state table 71 and selects a terminal ID, the transfer order N of which is set to the first place. In ACT 63, the processor 31 controls the communication unit 35 to transmit a state check command to the checkout machine 12 identifies by the selected terminal ID, that is, the first checkout machine 12-1. According to the control, the state check command is transmitted to the first checkout machine 12-1.

In ACT 64, the processor 31, which controlled the transmission of the state check command, checks whether a transmission error occurs. For example, if the first checkout machine 12-1 is broken down, an error occurs in the transmission of the state check command. If the error occurs in the transmission of the state check command, the processor 31 proceeds to YES in ACT 64 and shifts to processing in ACT 67. Processing in ACT 67 and subsequent acts is explained below.

The processor 51 of the first checkout machine 12-1 receives the state check command and collects information necessary for a state check, so-called checkout machine information. The processor 51 controls the communication unit 55 to transmit a check response command including the checkout machine information to the registration machine 11-1. According to the control, the check response command is transmitted to the registration machine 11-1. The checkout machine information is included in the check response command. The checkout machine information is, for example, information for identifying whether an operation mode of the first checkout machine 12-1 is a checkout machine mode or a training mode, information for identifying whether an error is occurring in the printer 59, and information for identifying whether an error is occurring in the change machine connected to the change machine interface 56. The checkout machine information is not limited to the information explained above.

If an error does not occur in the transmission of the state check command, the processor 31 proceeds to YES in ACT 64. In ACT 65, the processor 31 waits for a check response command from the first checkout machine 12-1. If receiving the check response command via the communication unit 35, the processor 31 proceeds to YES in ACT 65. In ACT 66, the processor 31 stores the checkout machine information included in the check response command in a temporary memory of the main memory 32. Thereafter, the processor 31 proceeds to ACT 67.

In this way, if an error occurs in the transmission of the state check command or the checkout machine information of the response command to the state check command is stored in the temporary memory, the processor 31 shifts to processing in ACT 67.

In ACT 67, the processor 31 acquires the checkout machine state flag 81. In ACT 68, the processor 31 controls the communication unit 35 to transmit a check end notification command to a transmission source of the check start notification command. According to the control, if the transmission source of the check start notification command is the first checkout machine 12-1, the check end notification command is transmitted to the first checkout machine 12-1. If the transmission source of the check start notification command is the second checkout machine 12-2, the check end notification command is transmitted to the second checkout machine 12-2. The checkout machine state flag 81 acquired in the processing in ACT 67 is included in the check end notification command. If the checkout machine information is stored in the temporary memory in ACT 66, the checkout machine information is also included in the check end notification command. The temporary memory is cleared.

Then, the processor 31 ends the second information processing.

In this way, every time the registration machine 11-1 receives the check start notification command as periodically transmitted from the corresponding first checkout machine 12-1 or the second checkout machine 12-2, the registration machine 11-1 acquires checkout machine information of the first checkout machine 12-1 (the primary destination). The registration machine 11-1 transmits the check end notification command including the acquired checkout machine information and the checkout machine state flag 81 for the present point in time to whichever of the first checkout machine 12-1 or the second checkout machine 12-2 sent the check start notification command. If acquiring the checkout machine information from the first checkout machine 12-1 fails, the registration machine 11-1 transmits the check end notification command including the checkout machine state flag 81. The check end notification command may include, in addition to the checkout machine state flag 81, information indicating that the registration machine 11-1 failed in acquiring the checkout machine information.

The processor 31 of the registration machine 11-1 realizes the function of the state checking unit 313 by executing the processing in ACT 62 to ACT 68.

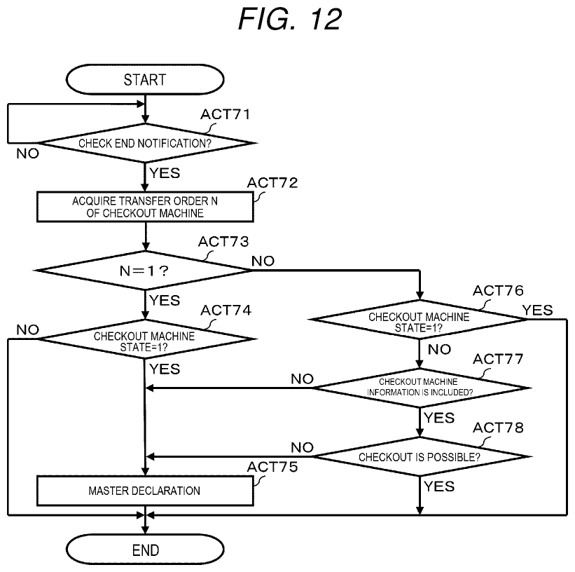

FIG. 12 is a flowchart illustrating a procedure of the seventh information processing executed by the processor 51 of the first checkout machine 12-1 and the second checkout machine 12-2 according to the settlement program. In ACT 71, the processor 51 waits for the check end notification command. If receiving the check end notification command via the communication unit 55, the processor 51 proceeds to YES in ACT 71. In ACT 72, the processor 51 refers to the connection state table 71 and acquires the transfer order N correlated with a terminal ID of the checkout machine 12.

In ACT 73, the processor 51 checks whether the transfer order N is the first place. If the transfer order N is the first place, that is, in the case of the first checkout machine 12-1, the processor 51 proceeds to YES in ACT 73. In ACT 74, the processor 51 checks the checkout machine state flag 81 included in the check end notification command. If the checkout machine state flag 81 is “0”, that is, if the registration machine 11-1 sets the first checkout machine 12-1 as a transmission destination of settlement information, the processor 51 proceeds to NO in ACT 74 and ends the seventh information processing.

If the checkout machine state flag 81 is “1”, that is, if the registration machine 11-1 does not set the first checkout machine 12-1 as the transmission destination of the settlement information, the processor 51 proceeds to YES in ACT 74. In ACT 75, the processor 51 controls the communication unit 55 to transmit a master declaration command to the registration machine 11-1. According to the control, the master declaration command is transmitted to the registration machine 11-1. The processor 51, which controlled the transmission of the master declaration command, ends the seventh information processing.

On the other hand, if the transfer order N is not the first place, that is, in the case of the second checkout machine 12-2, the processor 51 proceeds to NO in ACT 73. In ACT 76, the processor 51 checks the checkout machine state flag 81 included in the check end notification command. If the checkout machine state flag 81 is “1”, that is, if the registration machine 11-1 does not set the first checkout machine 12-1 as the transmission destination of the settlement information, that is, sets the second checkout machine 12-2 as the transmission destination, the processor 51 proceeds to YES in ACT 76 and ends the seventh information processing.

If the checkout machine state flag 81 is “0”, that is, if the registration machine 11-1 sets the first checkout machine 12-1 as the transmission destination of the settlement information, the processor 51 proceeds to NO in ACT 76. In ACT 77, the processor 51 checks whether the checkout machine information of the first checkout machine 12-1 is included in the check end notification command. If the checkout machine information is not included, the processor 51 proceeds to NO in ACT 77 and shifts to the processing in ACT 75 explained above. That is, the processor 51 controls the communication unit 55 to transmit the master declaration command to the registration machine 11-1 and ends the seventh information processing.

If the checkout machine information is included in the check end notification command, the processor 51 proceeds to YES in ACT 77. In ACT 78, the processor 51 analyzes the checkout machine information. The processor 51 determines whether the first checkout machine 12-1 is capable of performing checkout.

As explained above, as the checkout machine information, there are, for example, the information for identifying whether the operation mode of the first checkout machine 12-1 is the checkout machine mode or the training mode, the information for identifying whether an error is occurring in the printer 59, and the information for identifying whether an error is occurring in the change machine connected to the change machine interface 56. If the operation mode of the first checkout machine 12-1 is the checkout machine mode and an error is not occurring in the printer 59 and the change machine, the processor 51 determines that the first checkout machine 12-1 is capable of performing checkout. If the operation mode of the first checkout machine 12-1 is the training mode or an error is occurring in the printer 59 or the change machine, the processor 51 determines that the first checkout machine 12-1 is incapable of performing checkout.

If determining that the first checkout machine 12-1 is capable of performing checkout, the processor 51 proceeds to YES in ACT 78 and ends the seventh information processing.

If determining that the first checkout machine 12-1 is incapable of performing checkout, the processor 51 proceeds to NO in ACT 78 and executes the processing in ACT 75 explained above. That is, the processor 51 controls the communication unit 55 to transmit the master declaration command to the registration machine 11-1 and ends the seventh information processing.

In this way, if the checkout machine state flag 81 included in the check end notification command is “1”, the first checkout machine 12-1, the transfer order N of which is the first place, transmits the master declaration command to the registration machine 11-1. If the checkout machine state flag 81 is “1”, in the registration machine 11-1, the transmission destination of the settlement information is not set to the first checkout machine 12-1. Such an event can occur if the first checkout machine 12-1 breaks down. Thereafter, if the first checkout machine 12-1 is restored, the first checkout machine 12-1 transmits the check start notification command to the registration machine 11-1 again. As the checkout machine state flag 81, “1” is included in the check start notification command, which is the response command to the check start notification command. Therefore, the first checkout machine 12-1 transmits the master declaration command to the registration machine 11-1. That is, in the first checkout machine 12-1, if the checkout machine state flag 81 included in the check end notification command is “1”, the transmission destination change condition is satisfied.

On the other hand, if the checkout machine state flag 81 included in the check end notification command is “1”, that is, if the transmission destination of the settlement information is changed to the second checkout machine 12-2 in the registration machine 11-1, the second checkout machine 12-2, the transfer order N of which is the second place, does not transmit the master declaration command to the registration machine 11-1.

In contrast, if the checkout machine state flag 81 is “0”, the second checkout machine 12-2 transmits the master declaration command to the registration machine 11-1 if transmission destination change conditions explained below are satisfied.

A first condition is that checkout machine information is not included in the check end notification command. Checkout machine information not being included in the check end notification command means that the first checkout machine 12-1 breaks down. Therefore, the second checkout machine 12-2 transmits the master declaration command to the registration machine 11-1.

A second condition is that, as a result of analyzing the checkout machine information included in the check end notification command, it is recognized that the first checkout machine 12-1 is incapable of performing checkout. In this case as well, the second checkout machine 12-2 transmits the master declaration command to the registration machine 11-1.

The processor 31 of the first checkout machine 12-1 realizes the function of the change notifying unit 513 by executing the processing in ACT 71 to ACT 75. The processor 31 of the second checkout machine 12-2 realizes the function of the change notifying unit 513 by executing the processing in ACT 71 to ACT 73 and ACT 75 to ACT 78. In order to distinguish the change notifying unit 513 of the first checkout machine 12-1 and the change notifying unit 513 of the second checkout machine 12-2, the change notifying unit 513 of the second checkout machine 12-2 may be referred to as first change notifying unit 513 and the change notifying unit 513 of the first checkout machine 12-1 may be referred to as second change notifying unit 513.

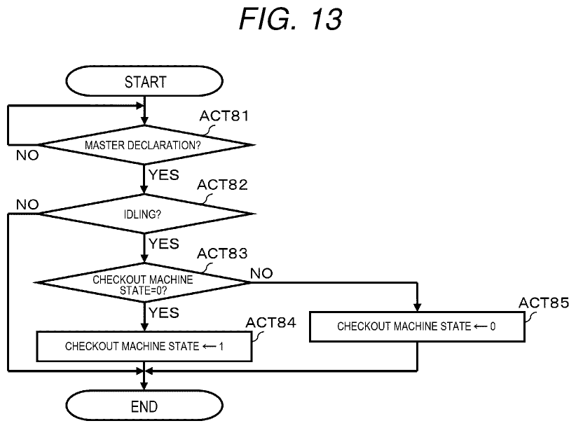

FIG. 13 is a flowchart illustrating a procedure of the third information processing executed by the processor 31 of the registration machine 11-1 according to the registration program. In ACT 81, the processor 31 waits for the master declaration command. If receiving the master declaration command via the communication unit 35, the processor 31 proceeds to YES in ACT 81. In ACT 82, the processor 31 checks whether the registration machine 11-1 is idling. The idling is a state in which the processor 31 is not executing the first information processing or the second information processing. If the registration machine 11-1 is not idling, the processor 31 proceeds to NO in ACT 82 and ends the third information processing.

If receiving the master declaration command while the registration machine 11-1 is idling, the processor 31 proceeds to YES in ACT 82. In ACT 83, the processor 31 checks the checkout machine state flag 81.

If the checkout machine state flag 81 is “0”, the processor 31 proceeds to YES in ACT 83. In ACT 84, the processor 31 changes the checkout machine state flag 81 from “0” to “1”. If the checkout machine state flag 81 is “1”, the processor 31 proceeds to NO in ACT 83. In ACT 85, the processor 31 changes the checkout machine state flag 81 from “1” to “0”. Then, the processor 31 ends the third information processing.

In this way, if receiving the master declaration command if the checkout machine state flag 81 is “0”, the registration machine 11-1 changes the checkout machine state flag 81 from “0” to “1”. It is the second checkout machine 12-2 that transmits the master declaration command if the checkout machine state flag 81 is “0”. If the checkout machine state flag 81 is changed from “0” to “1”, the processor 31 of the registration machine 11-1 proceeds to NO in ACT 9 of the first information processing and executes the processing in ACT 11. That is, the processor 31 selects the terminal ID of the second checkout machine 12-2, the transfer order N of which is set to the second place, from the connection state table 71. The processor 31 transmits the settlement information with the second checkout machine 12-2 specified by the terminal ID set as a transmission destination.

In this way, if the master declaration command is transmitted from the second checkout machine 12-2, the transmission destination of the settlement information is automatically changed from the first checkout machine 12-1 to the second checkout machine 12-2. The second checkout machine 12-2 transmits the master declaration command if the first condition or the second condition is satisfied. Therefore, in the transaction processing system 100, if the first checkout machine 12-1 breaks down or falls into a state in which checkout cannot be performed, the transmission destination of the settlement information is automatically changed from the first checkout machine 12-1 to the second checkout machine 12-2. Accordingly, settlement processing for the customer 22 is not delayed even if the first checkout machine 12-1 breaks down.

If receiving the master declaration command if the checkout machine state flag 81 is “1”, the registration machine 11-1 changes the checkout machine state flag 81 from “1” to “0”. It is the first checkout machine 12-1 that transmits the master declaration command if the checkout machine state flag 81 is “1”. If the checkout machine state flag 81 is changed from “1” to “0”, the processor 31 of the registration machine 11-1 proceeds to YES in ACT 9 of the first information processing and executes the processing in ACT 10. That is, the processor 31 selects the terminal ID of the first checkout machine 12-1, the transfer order N of which is set to the first place, from the connection state table 71. The processor 31 transmits the settlement information with the first checkout machine 12-1 specified by the terminal ID set as a transmission destination.

In this way, if the master declaration command is transmitted from the first checkout machine 12-1, the transmission destination of the settlement information is automatically changed from the second checkout machine 12-2 to the first checkout machine 12-1. The first checkout machine 12-1 transmits the master declaration command if the first checkout machine 12-1 broken down as explained above is restored. Therefore, if the first checkout machine 12-1 is restored from the breakdown, the transaction processing system 100 can quickly reset the transmission destination of the settlement information to the first checkout machine 12-1.

The processor 31 of the registration machine 11-1 realizes the function of the changing unit 314 by executing the processing in ACT 84. The processor 31 realizes the function of the restoring unit 315 by executing the processing in ACT 85.

A sequence of commands exchanged between the registration machine 11-1 and the first and second checkout machines 12-1 and 12-2 in the second function explained above is explained.

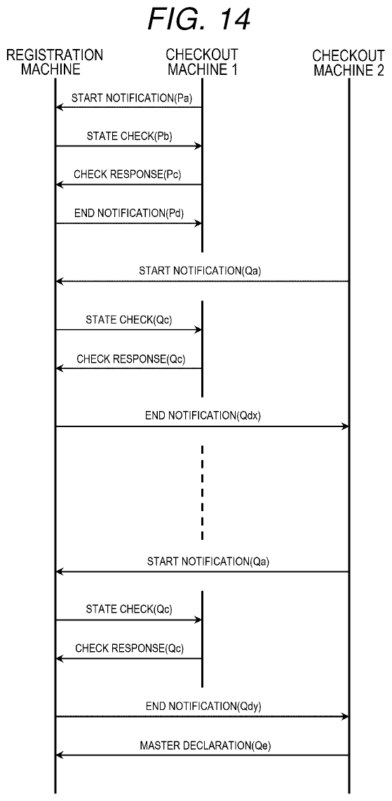

FIG. 14 is a sequence chart for when, for example, a printer error occurs in the first checkout machine 12-1 (“checkout machine 1”). Firstly, when a printer error is not yet occurring, the first checkout machine 12-1 transmits a check start notification command (Pa) to the registration machine 11-1. In response to the check start notification command (Pa), the registration machine 11-1 transmits a state check command (Pb) to the first checkout machine 12-1. Upon receiving a check response command (Pc) from the first checkout machine 12-1 in response to the state check command (Pb), the registration machine 11-1 transmits a check end notification command (Pd) including the checkout machine information and the checkout machine state flag 81 to the first checkout machine 12-1. At this time, since the checkout machine state flag 81 is “0”, the first checkout machine 12-1 does not transmit a master declaration command to the registration machine 11-1.

The second checkout machine 12-2 (“checkout machine 2”) transmits a check start notification command (Qa) to the registration machine 11-1 at some point. In response to the check start notification command (Qa), the registration machine 11-1 transmits a state check command (Qb) to the first checkout machine 12-1. Upon receiving a check response command (Qc) from the first checkout machine 12-1 in response to the state check command (Qb), the registration machine 11-1 transmits a check end notification command (Qdx) including the checkout machine information and the checkout machine state flag 81 to the second checkout machine 12-2. At this time, the checkout machine state flag 81 is “0” and the checkout machine information does not satisfy a transmission destination change condition, so the second checkout machine 12-2 does not transmit a master declaration command to the registration machine 11-1.

At this point in time, the settlement information will be transmitted from the registration machine 11-1 to the first checkout machine 12-1. If the first checkout machine 12-1 is capable of performing settlement, settlement processing is executed in the first checkout machine 12-1. However, if the first checkout machine 12-1 is in a busy state or the like, the settlement information is transferred from the first checkout machine 12-1 to the second checkout machine 12-2. The settlement processing is thus executed in the second checkout machine 12-2 when the first checkout machine 12-1 is busy.

Subsequently, it is assumed in this example that a printer error occurs in the first checkout machine 12-1 and the first checkout machine 12-1 becomes unavailable for settlement processing as indicated by a check response (Qc). In this case, checkout machine information included in the check end notification command (Qdy) transmitted from the registration machine 11-1 to the second checkout machine 12-2 satisfies the transmission destination change condition. Therefore, the second checkout machine 12-2 transmits a master declaration command (Qe) to the registration machine 11-1. As a result, the transmission destination of the settlement information is changed from the first checkout machine 12-1 to the second checkout machine 12-2. Thereafter, settlement processing is executed in the second checkout machine 12-2.

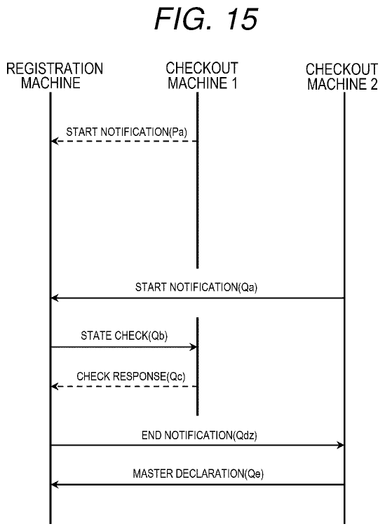

FIG. 15 is a sequence chart at the time when the first checkout machine 12-1 breaks down entirely or otherwise fails to be able to communicate with the registration machine 11-1 anymore. Since the first checkout machine 12-1 is broken down in this example, the first checkout machine 12-1 does not actually transmit a check start notification command (Pa). Accordingly, the exchange of a state check command (Pb), a check response command (Pc), and a check end notification command (Pd) between the registration machine 11-1 and the first checkout machine 12-1 as initiated by a check start notification command (Pa) (compare to FIG. 14) is not performed.

However, even in this example, a check start notification command (Qa) is still transmitted from the second checkout machine 12-2. In response to this check start notification command (Qa), the registration machine 11-1 transmits the state check command (Qb) to the first checkout machine 12-1. However, here an error occurs in response to the transmission of the state check command (Qb). The check response command (Qc) cannot be or is not received from the first checkout machine 12-1. Accordingly, checkout machine information is not included in a check end notification command (Qdz) transmitted from the registration machine 11-1 to the second checkout machine 12-2. In such a case, a transmission destination change condition is satisfied. Therefore, the second checkout machine 12-2 transmits a master declaration command (Qe) to the registration machine 11-1. As a result, thereafter, settlement information is transmitted from the registration machine 11-1 directly to the second checkout machine 12-2 rather than to the first checkout machine 12-1. Settlement processing is executed in the second checkout machine 12-2.

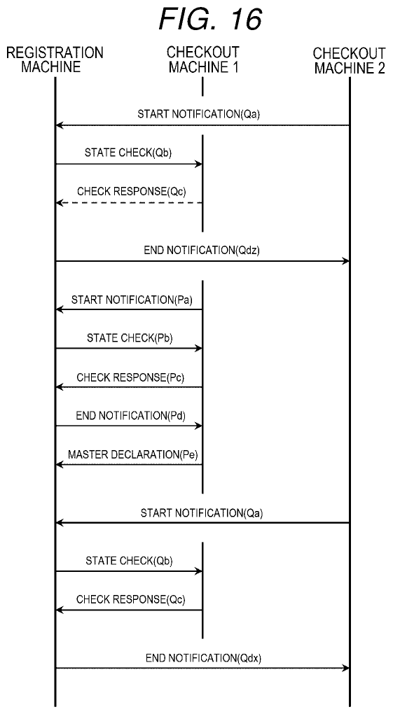

FIG. 16 is a sequence chart for when the first checkout machine 12-1 is restored after breakdown. At some point before the first checkout machine 12-1 is restored, the checkout machine state flag 81 included in the check end notification command (Qdz) transmitted from the registration machine 11-1 to the second checkout machine 12-2 is set to “1”. Therefore, the second checkout machine 12-2 does not transmit a master declaration command (Qe) at this time.

If the first checkout machine 12-1 is restored at this point, the first checkout machine 12-1 resumes the transmission of the check start notification commands (Pa). In response to a check start notification command (Pa), the registration machine 11-1 transmits the state check command (Pb) to the first checkout machine 12-1. Upon receiving a satisfactory check response command (Pc) from the first checkout machine 12-1, the registration machine 11-1 transmits a check end notification command (Pd) including the checkout machine information and the checkout machine state flag 81 to the first checkout machine 12-1. At this time, since the checkout machine state flag 81 is presently set to “1”, the first checkout machine 12-1 also transmits a master declaration command (Pe) to the registration machine 11-1. As a result, the transmission destination for the settlement information is reset from the second checkout machine 12-2 to the first checkout machine 12-1.

Thereafter, checkout machine information in a normal state is included in the check end notification command (Qdx) transmitted from the registration machine 11-1 to the second checkout machine 12-2 in response to the check start notification command (Qa) from the second checkout machine 12-2. The checkout machine state flag 81 is changed to “0”. Therefore, the second checkout machine 12-2 does not transmit the master declaration command (Qe).

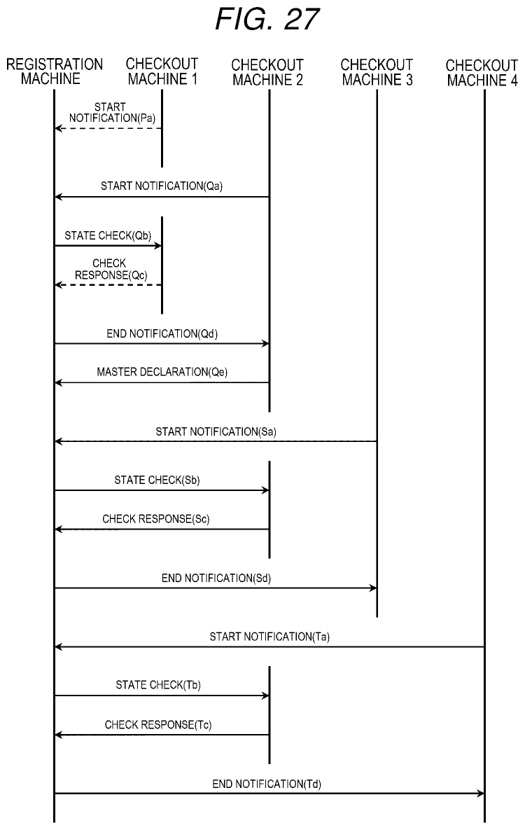

In examples of the sequences illustrated in FIGS. 14 to 16, the checkout machines 12-1 and 12-2 are illustrated as transmitting the check start notification commands (Pa and Qa) only after the check end notification commands (Pd and Qd) are sent from the registration machine 11-1. However, the timing for transmitting the check start notification commands (Pa, Qa, Sa (see FIG. 27), and Ta (see FIG. 27)) is not particularly limited. Accordingly, in some cases, it could occur that the registration machine 11-1 receives the check start notification commands (Pa and Qa) from the second checkout machine 12-2 before transmitting the check end notification commands (Pd and Qd) to first checkout machine 12-1. In such a case, after transmitting the check end notification commands (Pd and Qd) to one of the checkout machines, the registration machine 11-1 executes processing corresponding to the check start notification commands (Pa and Qa) from the other one of the checkout machines, that is, transmission of a state check command, reception of a check response command, and transmission of a check end notification command.

As explained above, with the transaction processing system 100, even if the first checkout machine 12-1 breaks down and the settlement information cannot be transmitted from the registration machine 11 to the first checkout machine 12-1, the transmission destination of the settlement information is quickly changed to the second checkout machine 12-2. The same holds true if a minor failure such as a printer error or a change machine error occurs in the first checkout machine 12-1 and settlement cannot be normally performed. Therefore, even if an abnormality occurs in the first checkout machine 12-1, which is set the primary transmission destination of the settlement information, it is possible to prevent settlement of a transaction from being delayed. As a result, it is possible to provide a transaction processing system with high processing efficiency.

If the first checkout machine 12-1 is restored at some point after a failure, the transmission destination of the settlement information can be quickly reset to the first checkout machine 12-1. In general, in a semi-self-service type transaction processing system, a checkout machine having satisfactory customer movement efficiency tends to be set as the first checkout machine 12-1. Therefore, it is possible to minimize influence involved in an abnormality of the first checkout machine 12-1.

The registration machine 11 has 1-bit information (state flag 81) for identifying which checkout machine is functioning as the primary transmission destination of the settlement information. Therefore, a memory capacity of the registration machine 11 is not substantially affected.

In this embodiment, the processor 31 of the registration machine 11 is explained as executing the second information processing and the third information processing according to the registration program. A program for causing the processor 31 to execute the second information processing and the third information processing is not limited to the registration program. The processor 31 may execute the second information processing and the third information processing according to a program different from the registration program. Similarly, a program for the processor 51 of the checkout machine 12 to execute the fifth information processing to the seventh information processing is not limited to the settlement program. The processor 51 may execute the fifth information processing to the seventh information processing according to a program different from the settlement program.

A checkout machine 12 that periodically transmits the check start notification command may just be a checkout machine 12 not presently set as the transmission destination of the settlement information in the registration machine 11. For example, as in this embodiment, if the first checkout machine 12-1 is the primary transmission destination, then only the second checkout machine 12-2 need periodically transmit the check start notification command. If the check end notification command returned as a response to the check start notification command satisfies the transmission destination change condition, the second checkout machine 12-2 transmits the master declaration command to the registration machine 11-1. The second checkout machine 12-2 would then stop the periodic transmission of the check start notification command. The first checkout machine 12-1 might transmit a check start notification command only at a startup time, for example. Consequently, if the first checkout machine 12-1 is restored after a failure, since the transmission destination is reset to the first checkout machine 12-1 at this time, the second checkout machine 12-2 would then resume the periodic transmission of the check start notification command. Even with such a configuration, the substantially similar effects as those already described for the example embodiment can be achieved.

### Second Embodiment

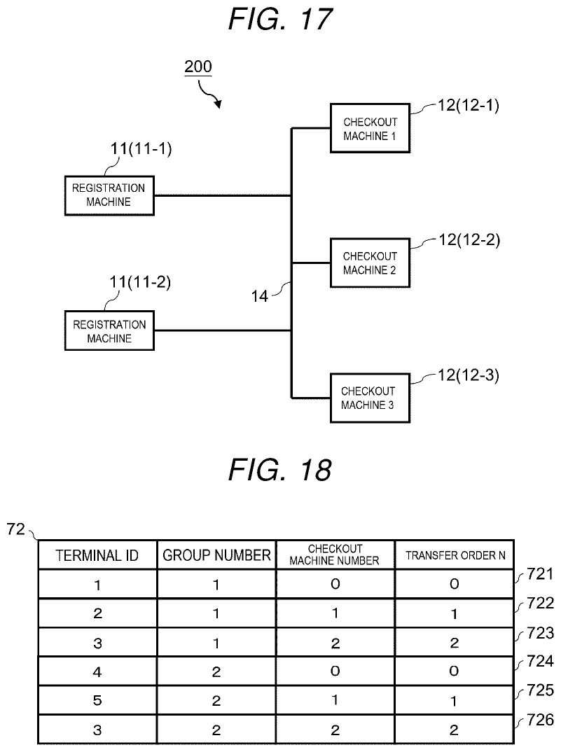

FIG. 17 is a conceptual diagram of a transaction processing system 200 according to a second embodiment. The transaction processing system 200 includes two registration machines 11 (11-1 and 11-2) and three checkout machines 12 (12-1, 12-2, and 12-3). The registration machines 11 and the checkout machines 12 are connected by the network 14. The server 13 is also connected to the network 14 as in the first embodiment, though this is not specifically depicted in FIG. 17.

In the transaction processing system 200, one group is formed by the registration machine 11-1 and the two checkout machines 12-1 and 12-2. In the transaction processing system 200, another group is formed by the registration machine 11-2 and the two checkout machines 12-2 and 12-3. That is, a first registration machine 11-1 and a second registration machine 11-2 both share the checkout machine 12-2. Therefore, in the second embodiment, as in the first embodiment, the transaction processing system 200 is a transaction processing system in which one registration machine and two checkout machines form a group.

Hardware configurations of the registration machines 11-1 and 11-2 and the checkout machines 12-1, 12-2, and 12-3 are the same as the hardware configurations in the first embodiment and thus correspond to those of FIGS. 2 and 3 already described. The registration machines 11-1 and 11-2 each include the checkout machine state flag 81 as in the first embodiment. In the following explanation, the checkout machine state flag 81 included in the registration machine 11-1 is designated as checkout machine state flag 811 and the checkout machine state flag 81 included in the registration machine 11-2 is designated as checkout machine state flag 812 to distinguish the checkout machine state flags 81.

FIG. 18 is a schematic diagram illustrating a main data structure of a connection state table 72 included in each of the registration machines 11-1 and 11-2 and the checkout machines 12-1, 12-2, and 12-3. The connection state table 72 is stored in, for example, the auxiliary storage devices 33 and 53. The registration machines 11-1 and 11-2 and the checkout machines 12-1, 12-2, and 12-3 in two groups that share the checkout machine 12-2 include the connection state table 72 having the same content.

The connection state table 72 includes, as illustrated in FIG. 18, data records 721, 722, 723, 724, 725, and 726 formed by individual elements such as a terminal ID, a group number, a checkout machine number, and the transfer order N. The data record 721 is a data record concerning the registration machine 11-1. The data record 722 is a data record concerning the checkout machine 12-1. The data record 723 is a data record concerning the checkout machine 12-2. The data record 724 is a data record concerning the registration machine 11-2. The data record 725 is a data record concerning the checkout machine 12-3. The data record 726 is a data record concerning the checkout machine 12-2. In this way, concerning the checkout machine 12-2 shared by the two groups, the data record 723 and the data record 726 respectively corresponding to the groups are described in the connection state table 72.

The terminal ID is specific identification information set for each of terminals such as the registration machines 11-1 and 11-2 and the checkout machines 12-1, 12-2, and 12-3.

The group number is a number set for each of the groups in order to identify a group formed by one registration machine 11 and two checkout machines 12. Therefore, a group number of the data records 721, 722, and 723 for the registration machine 11-1, the checkout machine 12-1, and the checkout machine 12-2 forming one group is common. A group number of the data records 724, 725, and 726 for the registration machine 11-2, the checkout machine 12-3, and the checkout machine 12-2 forming the other group is common.

The checkout machine number is a serial number from “1” set for each of checkout machines in order to individually identify the two checkout machines 12-1 and 12-2 forming the same group. “0” is set as the checkout machine number for the registration machine 11-1 forming the same group.

The transfer order N is a serial number from “1” indicating the transfer order N to the two checkout machines 12-1 and 12-2 of settlement information transmitted from the registration machine 11 forming the same group. In this embodiment, for the group to which one registration machine 11-1 belongs, the transfer order N of the checkout machine 12-1 having the checkout machine number “1” is set as first place and the transfer order N of the checkout machine 12-2 having the checkout machine number “2” is set as second place. For the group to which the other registration machine 11-2 belongs, the transfer order N of the checkout machine 12-3 having the checkout machine number “3” is set as first place and the transfer order N of the checkout machine 12-2 having the checkout machine number “2” is set as second place. In the following explanation, for convenience of explanation, one registration machine 11-1 is referred to as first registration machine 11-1 and the other registration machine 11-2 is referred to as second registration machine 11-2. The checkout machine 12-1 having the checkout machine number “1” is referred to as first checkout machine 12-1, the checkout machine 12-2 having the checkout machine number “2” is referred to as second checkout machine 12-2, and the checkout machine 12-3 having the checkout machine number “3” is referred to as third checkout machine 12-3. The first checkout machine 12-1 and the third checkout machine 12-3 can also be referred to as a master, a master machine, a primary machine, or the like because the transfer order N thereof is the first place. The second checkout machine 12-2 can also be referred to as a slave, a satellite machine, a secondary machine, or the like because the transfer order N thereof is the second place. The transfer order N of a second checkout machine 12-2 shared by two groups may be set as the first place in one group and set as the second place in the other group.

Functions of the transaction processing system 200 are basically the same as the functions of the transaction processing system 100 in the first embodiment. Therefore, the flowcharts of FIGS. 6 to 13 explained in the first embodiment are adopted for explanation of the second embodiment as well. Explanation with reference to the flowcharts is omitted.

However, in the second embodiment, the second checkout machine 12-2 is shared by the two groups. Accordingly, in the connection state table 72, as data records concerning the second checkout machine 12-2, the data record 723 for a group having a group number “1” and the data record 726 for a group having a group number “2” are described. As a result, the second checkout machine 12-2 not only periodically transmits the check start notification command to the first registration machine 11-1 belonging to the group having the group number “1” but also periodically transmits the check start notification command to the second registration machine 11-2 belonging to the group having the group number “2”.

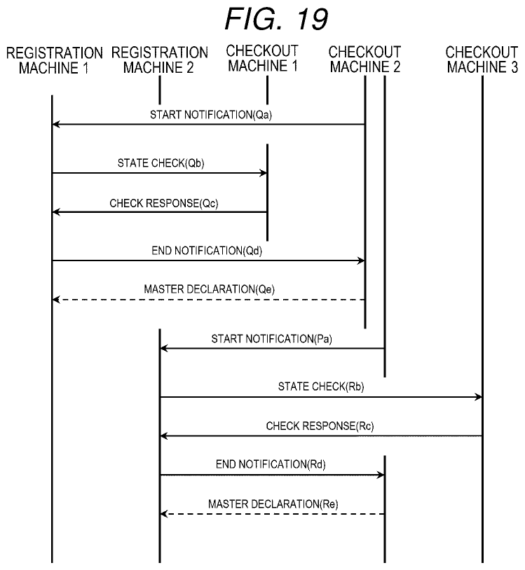

FIG. 19 is a sequence chart of commands exchanged between the first registration machine 11-1 (“registration machine 1”) and the second registration machine 11-2 “(registration machine 2”) and the first checkout machine 12-1 (“checkout machine 1”), the second checkout machine 12-2 (“checkout machine 2”), and the third checkout machine 12-3 (“checkout machine 3”). As illustrated, the second checkout machine 12-2 transmits a check start notification command (Qa) to the first registration machine 11-1 (belonging to group number “1”). In response to the check start notification command (Qa), the first registration machine 11-1 transmits the state check command (Qb) to the first checkout machine 12-1. Upon receiving the check response command (Qc) from the first checkout machine 12-1, the first registration machine 11-1 transmits a check end notification command (Qd) including checkout machine information and the checkout machine state flag 81 to the second checkout machine 12-2. If the transmission destination change condition is not satisfied, the second checkout machine 12-2 does not transmit the master declaration command (Qe) to the first registration machine 11-1. If the checkout machine state flag 811 is “0” and checkout machine information is not included in the check end notification command (Qd) or if an error identified in the checkout machine information occurs in the first checkout machine 12-1 and the transmission destination change condition is satisfied, the second checkout machine 12-2 transmits the master declaration command (Qe) to the first registration machine 11-1.

The second checkout machine 12-2 also transmits a check start notification command (Ra) to the second registration machine 11-2 (belonging to group number “2”). In response to the check start notification command (Ra), the second registration machine 11-2 transmits a state check command (Rb) to the third checkout machine 12-3. Upon receiving a check response command (Rc) from the third checkout machine 12-3, the second registration machine 11-2 transmits a check end notification command (Rd) including the checkout machine information and the checkout machine state flag 812 to the second checkout machine 12-2. If the transmission destination change condition is not satisfied, the second checkout machine 12-2 does not transmit a master declaration command (Re) to the second registration machine 11-2. If the checkout machine state flag 81 is “0” and checkout machine information is not included in the check end notification command (Rd) or if an error identified in the checkout machine information occurs in the third checkout machine 12-3 and the transmission destination change condition is satisfied, the second checkout machine 12-2 transmits the master declaration command (Re) to the second registration machine 11-2.

In the second embodiment, even if an abnormality occurs in the first checkout machine 12-1 or the third checkout machine 12-3, it is possible to prevent settlement from being delayed. Moreover, since the number of checkout machines necessary for forming the two groups can be reduced by sharing of the second checkout machine 12-2, there is an advantage that equipment costs can be reduced.

The number of groups sharing the same checkout machine 12 is not limited to two. Three or more groups may share a checkout machine 12.

### Third Embodiment

In the first and second embodiments, the transaction processing systems 100 and 200 in which the group is formed by the one registration machine 11 and the two checkout machines 12 are explained. In a third embodiment, a transaction processing system in which a group is formed by one registration machine 11 and three or more checkout machines 12 is explained.

### Configuration of the Transaction Processing System

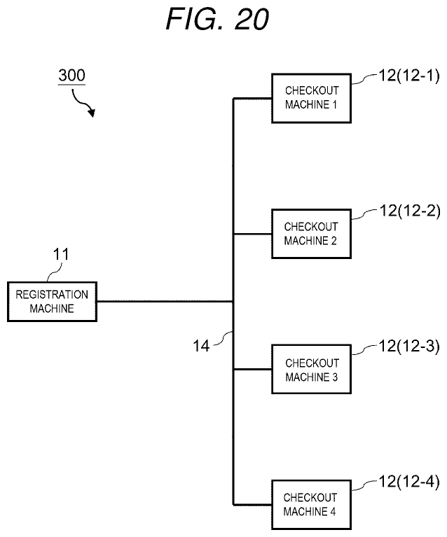

FIG. 20 is a diagram of a transaction processing system 300 according to the third embodiment. The transaction processing system 300 includes one registration machine 11 and four checkout machines 12-1, 12-2, 12-3, and 12-4. The registration machine 11 and the checkout machines 12-1, 12-2, 12-3, and 12-4 are connected by the network 14. Although not illustrated again, the server 13 is also connected to the network 14 as in the first embodiment.

In the transaction processing system 300, one group is formed by the registration machine 11 and the four checkout machines 12-1, 12-2, 12-3, and 12-4. The number of checkout machines 12 can be any number of three or more. For example, a group formed by three checkout machines 12 and a group formed by four checkout machines 12 may be mixed to form one transaction processing system.

Hardware configurations of the registration machine 11 and the checkout machines 12-1, 12-2, 12-3, and 12-4 are the same as in the first embodiment. Therefore, in the third embodiment, FIGS. 2 and 3 are referred to in this regard and repeated explanation is omitted.

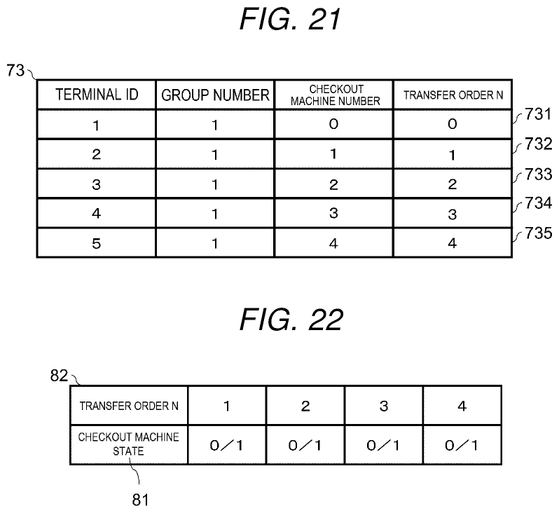

FIG. 21 is a schematic diagram illustrating a main data structure of a connection state table 73 included in each of the registration machine 11 and the checkout machines 12-1, 12-2, 12-3, and 12-4 forming one group. The connection state table 73 is stored in, for example, the auxiliary storage devices 33 and 53.

The connection state table 73 includes, as illustrated in FIG. 21, data records 731, 732, 733, 734, and 735 formed by individual elements such as a terminal ID, a group number, a checkout machine number, and the transfer order N. The data record 731 is a data record concerning the registration machine 11. The data record 732 is a data record concerning the checkout machine 12-1. The data record 733 is a data record concerning the checkout machine 12-2. The data record 734 is a data record concerning the checkout machine 12-3. The data record 735 is a data record concerning the checkout machine 12-4.

The terminal ID is specific identification information set for each of terminals such as the registration machine 11 and the checkout machines 12-1, 12-2, 12-3, and 12-4.

The group number is a number set for each of groups in order to identify a group formed by one registration machine 11 and four checkout machines 12-1, 12-2, 12-3, and 12-4. Therefore, a group number of the connection state table 73 for one group is shared. The group number may be a serial number or may not be the serial number. The group number only has to not overlap at least a group number of another group.

The checkout machine number is a serial number from “1” set for each of checkout machines in order to individually identify the four checkout machines 12-1, 12-2, 12-3, and 12-4 forming the same group. “0” is set as the checkout machine number for the registration machine 11 forming the same group.

The transfer order N is a serial number from “1” indicating the transfer order N to the four checkout machines 12-1, 12-2, 12-3, and 12-4 of settlement information transmitted from the registration machine 11 forming the same group. In this embodiment, the transfer order N of the checkout machine 12-1 having the checkout machine number “1” is set as first place, the transfer order N of the checkout machine 12-2 having the checkout machine number “2” is set as second place, the transfer order N of the checkout machine 12-3 having the checkout machine number “3” is set as third place, and the transfer order N of the checkout machine 12-4 having the checkout machine number “4” is set as fourth place. “0” is set as the transfer order N for the registration machine 11.

In the following explanation, for convenience, the checkout machine 12-1 having the checkout machine number “1” is referred to as first checkout machine 12-1, the checkout machine 12-2 having the checkout machine number “2” is referred to as second checkout machine 12-2, the checkout machine 12-3 having the checkout machine number “3” is referred to as third checkout machine 12-3, and the checkout machine 12-4 having the checkout machine number “4” is referred to as fourth checkout machine 12-4. The first checkout machine 12-1 can also be referred to as a master, a master machine, a primary machine, or the like because the transfer order N thereof is set to the first place in the order. The second checkout machine 12-2, the third checkout machine 12-3, and the fourth checkout machine 12-4 can also be referred to as a slave, satellite machine, a secondary machine, or the like because the transfer order N thereof is the second place or lower in the order.

FIG. 22 is a schematic diagram illustrating a data structure of a checkout machine state table 82 included in the registration machine 11. The checkout machine state table 82 is stored in, for example, the volatile memory region of the main memory 32. The checkout machine state table 82 is a data table for specifying, among the checkout machines 12-1 12-2, 12-3, and 12-4 in the first place to the fourth place of the transfer order N, a checkout machine in which place is set as a transmission destination of settlement information.

The checkout machine state table 82 stores the checkout machine flag 81 for each transfer order N. The checkout machine state flag 81 is 1-bit data of “0” or “1”. In this embodiment, a value of the checkout machine state flag 81 indicating that a checkout machine is set as a transmission destination is set to “1” and the checkout machine state flag 81 indicating that the checkout machine is not set as the transmission destination is set to “0”. The checkout machine set as the transmission destination is one checkout machine. Therefore, as the checkout machine state flag 81 stored in the checkout machine state table 82, the checkout machine state flag 81 corresponding to any one transfer order N is “1” and the checkout machine state flag 81 corresponding to the other transfer orders N is “0”. In default, the checkout machine state flag 81, the transfer order N of which is first place, is “1” and the checkout machine state flag 81, the transfer order N of which is second place to fourth place, is “0”. In the following explanation, a checkout machine in which the transfer order N, the checkout machine state flag 81 corresponding to which is “1”, is set is referred to as transmission destination checkout machine 12-X. In the checkout machine state flag 81, a value of the checkout machine state flag 81 indicating that a checkout machine is set as a transmission destination may be set to “1” and a value of the checkout machine state flag 81 indicating that the checkout machine is not set as the transmission destination may be set to “0”.

### Functions of the Transaction Processing System

A first function of the transaction processing system 300 is the same as the function of the transaction processing system 100 in the first embodiment except the processing in ACT 8 to ACT 11 executed by the processor 31 of the registration machine 11 according to the first information processing. Therefore, the flowcharts of FIGS. 6, 8, and 9 referred to for the first embodiment are adopted with regard to the third embodiment as well and repeated explanation is omitted. The first checkout machine 12-1 corresponds to the processing illustrated in FIG. 8. The second checkout machine 12-2, the third checkout machine 12-3, and the fourth checkout machine 12-4 correspond to the processing illustrated in FIG. 9.

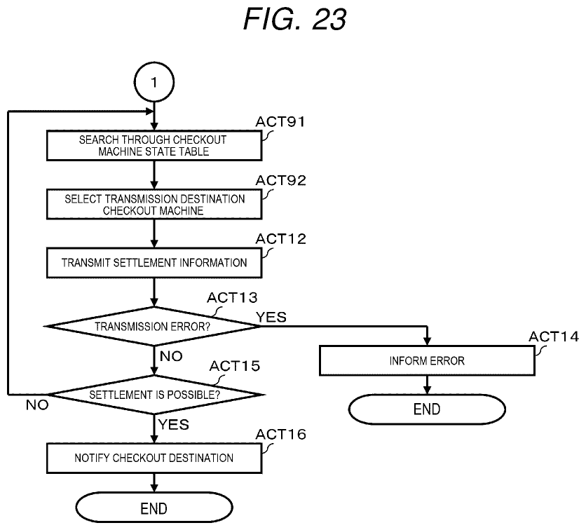

FIG. 23 is a flowchart illustrating aspects of the processing in ACT 7 and subsequent acts executed by the processor 31 of the registration machine 11 according to the first information processing. Portions common to FIG. 7 explained in the first embodiment are denoted by the same reference signs.

That is, after creating the settlement information in ACT 7 in FIG. 6, the processor 31 proceeds to ACT 91 in FIG. 23. In ACT 91, the processor 31 searches through the checkout machine state table 82 and recognizes transfer order, the checkout machine state flag 81 corresponding to which is “1”. In ACT 92, the processor 31 refers to the connection state table 73 and selects the transmission destination checkout machine 12-X for which the transfer order is set. In ACT 12, the processor 31 controls the communication unit 35 to transmit settlement information to the transmission destination checkout machine 12-X. Thereafter, the processor 31 executes the same processing as the processing in ACT 13 to ACT 16 explained in the first embodiment.

In this way, after creating the settlement information, the registration machine 11 selects the transmission destination checkout machine 12-X based on the information of the connection state table 73 and the checkout machine state table 82 and transmits the settlement information to the transmission destination checkout machine 12-X.

The processor 31 realizes the function of the creating unit 311 by executing the processing in ACT 7 in FIG. 6. The processor 31 realizes the function of the transmitting unit 312 by executing the processing in ACT 91, ACT 92, and ACT 12 in FIG. 23.

For example, if the first checkout machine 12-1 is a transmission destination (primary) checkout machine, the settlement information is transmitted from the registration machine 11 to the first checkout machine 12-1. At this time, if the first checkout machine 12-1 is capable of performing settlement, the customer 22 can perform settlement of a transaction using the first checkout machine 12-1.

On the other hand, if the first checkout machine 12-1 is in, for example, a busy state, the settlement information is transmitted from the first checkout machine 12-1 to the second checkout machine 12-2. If the second checkout machine 12-2 is also in, for example, the busy state, the settlement information is transmitted from the second checkout machine 12-2 to the third checkout machine 12-3. Therefore, if any checkout machine belonging to the same group is capable of performing checkout, the customer 22 can settle a transaction.

However, if the first checkout machine 12-1 is broken down, the settlement information is not transmitted to any checkout machines 12 belonging to the same group. Therefore, the customer 22 cannot settle a transaction. The transaction processing system 300 also includes a second function in order to solve such a deficiency. The second function is substantially similar to the function of the transaction processing system 100 in the first embodiment. That is, the processor 31 of the registration machine 11 includes the functions of the state checking unit 313, the changing unit 314, and the restoring unit 315 in order to realize the second function. The processor 51 of the first checkout machine 12-1, the second checkout machine 12-2, the third checkout machine 12-3, and the fourth checkout machine 12-4 includes the functions of the check notifying unit 512 and the change notifying unit 513. The function of the state checking unit 313 is based on the second information processing. The functions of the changing unit 314 and the restoring unit 315 are based on the third information processing. The function of the check notifying unit 512 is based on the sixth information processing. The function of the change notifying unit 513 is based on the seventh information processing.

A procedure of the sixth information processing executed by the processor 51 of the first checkout machine 12-1, the second checkout machine 12-2, the third checkout machine 12-3, and the fourth checkout machine 12-4 is the same as the procedure in the first embodiment. Therefore, FIG. 10 is adopted in the third embodiment as well. In the following explanation, the first checkout machine 12-1, the second checkout machine 12-2, the third checkout machine 12-3, and the fourth checkout machine 12-4 are collectively referred to as checkout machine 12-K.

Every time notification timing for a checkout machine check notification comes in ACT 51, in ACT 52, the processor 51 of the checkout machine 12-K controls the communication unit 55 to transmit a check start notification command to the registration machine 11. According to the control, the check start notification command is periodically transmitted from the checkout machine 12-K to the registration machine 11.

The processor 51 of the checkout machine 12-K realizes the function of the check notifying unit 512 with the processing in ACT 51 and ACT 52.

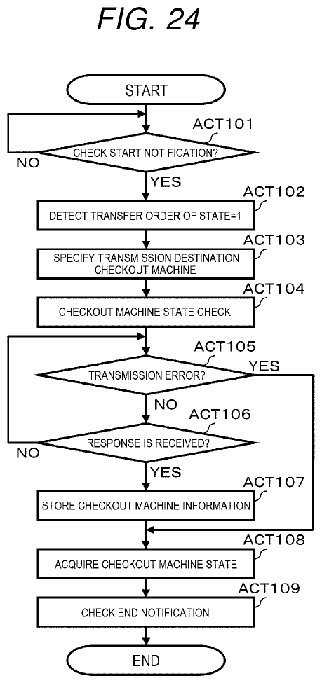

FIG. 24 is a flowchart illustrating a procedure of second information processing executed by the processor 31 of the registration machine 11. In ACT 101, the processor 31 waits for the check start notification command. If receiving the check start notification command via the communication unit 35, the processor 31 proceeds to YES in ACT 101. In ACT 102, the processor 31 refers to the checkout machine state table 82 and detects the transfer order N, the checkout machine state flag 81 corresponding to which is set to “1”. Subsequently, in ACT 103, the processor 31 refers to the connection state table 73 and specifies a terminal ID of a checkout machine in which the transfer order N detected in the processing in ACT 102 is set, that is, the transmission destination checkout machine 12-X.

In ACT 104, the processor 31 controls the communication unit 35 to transmit a state check command to the transmission destination checkout machine 12-X. According to the control, the state check command is transmitted to the transmission destination checkout machine 12-X.

In ACT 105, the processor 31, which controlled the transmission of the state check command, checks whether a transmission error occurs. For example, if the transmission destination checkout machine 12-X is broken down, an error occurs in the transmission of the state check command. If the error occurs in the transmission of the state check command, the processor 31 proceeds to YES in ACT 105 and shifts to processing in ACT 108. Processing in ACT 108 and subsequent acts is explained below.

The processor 51 of the transmission destination checkout machine 12-X receives the state check command and collects information necessary for a state check, so-called checkout machine information. The processor 51 controls the communication unit 55 to transmit a check response command including the checkout machine information to the registration machine 11. According to the control, the check response command is transmitted to the registration machine 11. The checkout machine information is included in the check response command. Content of the checkout machine information is the same as the content in the first embodiment.

If an error does not occur in the transmission of the state check command, the processor 31 proceeds to YES in ACT 105. In ACT 106, the processor 31 waits for the check response command from the transmission destination checkout machine 12-X. If receiving the check response command via the communication unit 35, the processor 31 proceeds to YES in ACT 106. In ACT 107, the processor 31 stores the checkout machine information included in the check response command in the temporary memory of the main memory 32. Thereafter, the processor 31 proceeds to ACT 108.

In this way, if an error occurs in the transmission of the state check command or the checkout machine information of the response command to the state check command is stored in the temporary memory, the processor 31 shifts to ACT 108.

In ACT 108, the processor 31 acquires data of the checkout machine state table 82. In ACT 109, the processor 31 controls the communication unit 35 to transmit a check end notification command to the checkout machine 12-K at a transmission source of the check start notification command. According to the control, if the transmission source of the check start notification command is the first checkout machine 12-1, the check end notification command is transmitted to the first checkout machine 12-1. If the transmission source of the check start notification command is the second checkout machine 12-2, the check end notification command is transmitted to the second checkout machine 12-2. If the transmission source of the check start notification command is the third checkout machine 12-3, the check end notification command is transmitted to the third checkout machine 12-3. If the transmission source of the check start notification command is the fourth checkout machine 12-4, the check end notification command is transmitted to the fourth checkout machine 12-4. The data of the checkout machine state table 82 acquired in the processing in ACT 108 is included in the check end notification command. If the checkout machine information is stored in the temporary memory in ACT 107, the checkout machine information is also included in the check end notification command. The temporary memory is cleared.

Then, the processor 31 ends the second information processing.

In this way, every time the registration machine 11 receives a check start notification command (which is periodically transmitted from the checkout machines 12-K in the same group), the registration machine 11 acquires the checkout machine information of the transmission destination checkout machine 12-X. The registration machine 11 transmits the check end notification command including the acquired checkout machine information and the data of the checkout machine state table 82 for the present point in time to the checkout machine 12-K, which sent the check start notification command. If acquiring the checkout machine information from the transmission destination checkout machine 12-X fails, the registration machine 11 transmits the check end notification command including only the data of the checkout machine state table 82. The check end notification command may include, in addition to the data of the checkout machine state table 82, information indicating that the checkout machine information was not successfully acquired.

The processor 31 of the registration machine 11 realizes the function of the state checking unit 313 by executing the processing in ACT 102 to ACT 109.

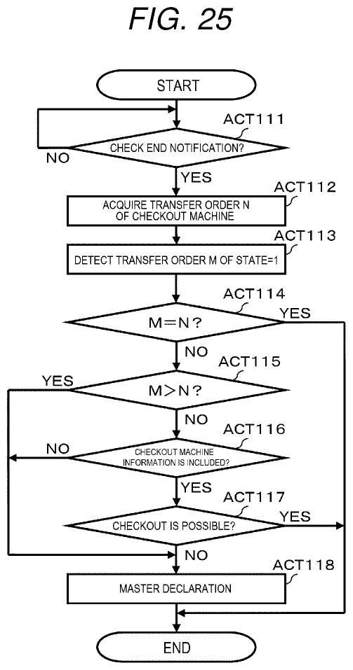

FIG. 25 is a flowchart illustrating a procedure of the seventh information processing executed by the processor 51 of the checkout machine 12-K according to the settlement program. In ACT 111, the processor 51 waits for the check end notification command. If receiving the check end notification command via the communication unit 55, the processor 51 proceeds to YES in ACT 111. In ACT 112, the processor 51 refers to the connection state table 71 and acquires the transfer order N correlated with a terminal ID of the checkout machine 12-K. In ACT 113, the processor 51 searches through the data of the checkout machine state table 82 included in the check end notification command and detects transfer order M, the checkout machine state flag 81 corresponding to which is “1”.

In ACT 114, the processor 51 checks whether transfer order M coincides with the transfer order N. If the transfer order M coincides with the transfer order N, that is, the checkout machine 12-K is the transmission destination checkout machine 12-X, the processor 51 proceeds to YES in ACT 114 and ends the seventh information processing.

If the transfer order M does not coincide with the transfer order N, the processor 51 proceeds to NO in ACT 114. In ACT 115, the processor 51 checks whether the transfer order M is larger than the transfer order N. If the transfer order M is larger than the transfer order N, that is, a checkout machine lower in transfer order than the checkout machine 12-K is the transmission destination checkout machine 12-X, the processor 51 proceeds to YES in ACT 115 and shifts to processing in ACT 118. Processing in ACT 118 and subsequent acts is explained below.

If the transfer order M is smaller than the transfer order N, that is, a checkout machine higher in transfer order than the checkout machine 12-K is the transmission destination checkout machine 12-X, the processor 51 proceeds to NO in ACT 115. In ACT 116, the processor 51 checks whether checkout machine information of the transmission destination checkout machine 12-X is included in the check end notification command. If the checkout machine information is not included, the processor 51 proceeds to NO in ACT 116 and shifts to the processing in ACT 118.

If the checkout machine information is included in the check end notification command, the processor 51 proceeds to YES in ACT 116. In ACT 117, the processor 51 analyzes the checkout machine information. As in the case explained as the processing in ACT 78 in the first embodiment, the processor 51 determines whether the transmission destination checkout machine 12-X is capable of performing checkout. If the transmission destination checkout machine 12-X is capable of performing checkout, the processor 51 proceeds to YES in ACT 117 and ends the seventh information processing. If the transmission destination checkout machine 12-X is incapable of performing checkout, the processor 51 proceeds to NO in ACT 117 and shifts to ACT 118.

In this way, if the transfer order M is larger than the transfer order N, if the checkout machine information of the transmission destination checkout machine 12-X is not included in the check end notification command, or if the transmission destination checkout machine 12-X is incapable of performing checkout, the processor 51 shifts to ACT 118. In ACT 118, the processor 51 controls the communication unit 55 to transmit a master declaration command to the registration machine 11. According to the control, the master declaration command is transmitted to the registration machine 11. The terminal ID of the checkout machine 12-K, which is a transmission source, is included in the master declaration command. The processor 51, which controlled the transmission of the master declaration command, ends the seventh information processing.

That is, if the transfer order M of the transmission destination checkout machine 12-X is higher than the transfer order N of the second checkout machine 12-2, the third checkout machine 12-3, or the fourth checkout machine 12-4, the second checkout machine 12-2, the third checkout machine 12-3, or the fourth checkout machine 12-4 checks whether the checkout machine information of the transmission destination checkout machine 12-X is included in the check end notification command. If the checkout machine information is not included, the second checkout machine 12-2, the third checkout machine 12-3, or the fourth checkout machine 12-4 transmits the master declaration command to the registration machine 11. If the checkout machine information is included but the checkout machine information satisfies the transmission destination change condition, the second checkout machine 12-2, the third checkout machine 12-3, or the fourth checkout machine 12-4 also transmits the master declaration command to the registration machine 11.

The processor 51 of the second checkout machine 12-2, the third checkout machine 12-3, or the fourth checkout machine 12-4 realizes the function of the change notifying unit 513 with the processing in ACT 116 to ACT 118.

On the other hand, if the transfer order M of the transmission destination checkout machine 12-X is lower than the transfer order N of the first checkout machine 12-1, the second checkout machine 12-2, or the third checkout machine 12-3, the first checkout machine 12-1, the second checkout machine 12-2, or the third checkout machine 12-3 transmits the master declaration command to the registration machine 11.

The processor 51 of the first checkout machine 12-1, the second checkout machine 12-2, or the third checkout machine 12-3 realizes the function of the change notifying unit 513 by executing the processing in ACT 115 and ACT 118. The former change notifying unit 513 may be referred to as first change notifying unit 513 and the latter change notifying unit 513 may be referred to as second change notifying unit 513.

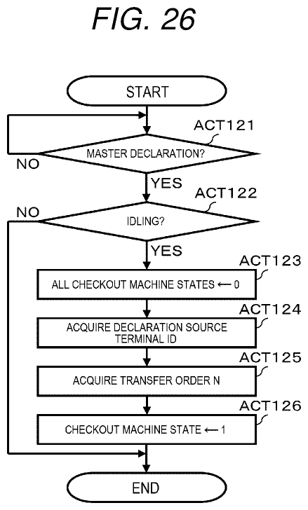

FIG. 26 is a flowchart illustrating a procedure of the third information processing executed by the processor 31 of the registration machine 11 according to the registration program. In ACT 121, the processor 31 waits for the master declaration command. If receiving the master declaration command via the communication unit 35, the processor 31 proceeds to YES in ACT 121. In ACT 122, the processor 31 checks whether the registration machine 11 is idling. The idling is a state in which the processor 31 is not executing the first information processing, the second information processing, or the like. If the registration machine 11 is not idling, the processor 31 proceeds to NO in ACT 122 and ends the third information processing.

If receiving the master declaration command while the registration machine 11 is idling, the processor 31 proceeds to YES in ACT 122. In ACT 123, the processor 31 sets all checkout machine state flags 81 of the checkout machine state table 82 to “0”.

In ACT 124, the processor 31 acquires the terminal ID of the checkout machine 12-K that transmits the master declaration command. Subsequently, in ACT 125, the processor 31 refers to the connection state table 73 and acquires the transfer order N of the checkout machine 12-K in which the terminal ID is set. In ACT 126, the processor 31 sets the checkout machine state flag 81 corresponding to the transfer order N to “1”. Then, the processor 31 ends the third information processing.

In this way, for example, if receiving the master declaration command from the second checkout machine 12-2, the transfer order of which is the second place, if the transmission destination checkout machine 12-X is the first checkout machine 12-1, that is, if the checkout state flag 81, the transfer order corresponding to which is the first place, is “1”, the registration machine 11 changes the checkout machine state flag 81, the transfer order corresponding to which is the first place, in the checkout machine state table 82 to “0” and changes the checkout machine state flag 81, the transfer order corresponding to which is the second place, in the checkout machine state table 82 to “1”. As a result, in the registration machine 11, the second checkout machine 12-2 is selected as the transmission destination checkout machine 12-X by the processing in ACT 91 and ACT 92 in FIG. 23 and the settlement information is transmitted to the second checkout machine 12-2. If the second checkout machine 12-2 is capable of performing settlement, the customer 22 can settle a transaction using the second checkout machine 12-2.

If receiving the master declaration command from the third checkout machine 12-3, the transfer order of which is the third place, if the transmission destination checkout machine 12-X is the second checkout machine 12-2, that is, if the checkout state flag 81, the transfer order corresponding to which is the second place, is “1”, the registration machine 11 changes the checkout machine state flag 81, the transfer order corresponding to which is the second place, in the checkout machine state table 82 to “0” and changes the checkout machine state flag 81, the transfer order corresponding to which is the third place, in the checkout machine state table 82 to “1”. As a result, in the registration machine 11, the third checkout machine 12-3 is selected as the transmission destination checkout machine 12-X by the processing in ACT 91 and ACT 92 in FIG. 23 and the settlement information is transmitted to the third checkout machine 12-3. If the third checkout machine 12-3 is capable of performing settlement, the customer 22 can settle a transaction using the third checkout machine 12-3.

On the other hand, if receiving the master declaration command from the first checkout machine 12-1, the transfer order of which is the first place, if the transmission destination checkout machine 12-X is the second checkout machine 12-2, that is, if the checkout state flag 81, the transfer order corresponding to which is the second place, is “1”, the registration machine 11 changes the checkout machine state flag 81, the transfer order corresponding to which is the second place, in the checkout machine state table 82 to “0” and changes the checkout machine state flag 81, the transfer order corresponding to which is the first place, in the checkout machine state table 82 to “1”. As a result, in the registration machine 11, the first checkout machine 12-1 is selected as the transmission destination checkout machine 12-X by the processing in ACT 91 and ACT 92 in FIG. 23 and the settlement information is transmitted to the first checkout machine 12-1. If the first checkout machine 12-1 is capable of performing settlement, the customer 22 can settle a transaction using the first checkout machine 12-1.

The processor 31 of the registration machine 11 realizes the functions of the changing unit 314 and the restoring unit 315 by executing the processing in ACT 123 to ACT 126. The changing unit 314 and the restoring unit 315 may be collectively referred to as changing unit.

In the second function explained above, a sequence of commands exchanged between the registration machine 11 and the first checkout machine 12-2, the second checkout machine 12-2, the third checkout machine 12-3, and the fourth checkout machine 12-4 is explained.

FIG. 27 is a sequence chart at the time when the first checkout machine 12-1, which is the transmission destination checkout machine, breaks down. Since the first checkout machine 12-1 is broken down, the first checkout machine 12-1 does not transmit the check start notification command (Pa). Accordingly, exchange of the state check command (Pb), the check response command (Pc), and the check end notification command (Pd) performed between the registration machine 11 and the first checkout machine 12-1 according to the check start notification command (Pa) is not performed either.

On the other hand, the check start notification command (Qa) is transmitted from the second checkout machine 12-2. In response to the check start notification command (Qa), the registration machine 11 transmits the state check command (Qb) to the first checkout machine 12-1. However, an error occurs in the transmission of the state check command (Qb) and the check response command (Qc) cannot be received. Accordingly, checkout machine information is not included in the check end notification command (Qdz) transmitted from the registration machine 11 to the second checkout machine 12-2. The transfer order M (=1) of the first checkout machine 12-1, which is the transmission destination checkout machine, is smaller than the transfer order N (=2) of the second checkout machine 12-2. Therefore, since the transmission destination change condition is satisfied, the second checkout machine 12-2 transmits the master declaration command (Qe) to the registration machine 11. As a result, the second checkout machine 12-2 becomes the transmission destination checkout machine 12-X.

Thereafter, if a check start notification command (Sa) is transmitted from the third checkout machine 12-3, the registration machine 11 transmits a state check command (Sb) to the second checkout machine 12-2. If receiving a check response command (Sc) from the second checkout machine 12-2, the registration machine 11 transmits a check end notification command (Sd) including the checkout machine information and the data of the checkout machine state table 82 to the third checkout machine 12-3. At this time, the transfer order M (=2) of the second checkout machine 12-2, which is the transmission destination checkout machine, is smaller than the transfer order N (=3) of the third checkout machine 12-3. If the checkout machine information does not satisfy the transmission destination change condition, the third checkout machine 12-3 does not transmit the master declaration command to the registration machine 11. The same holds true if a check start notification command (Ta) is transmitted from the fourth checkout machine 12-4.

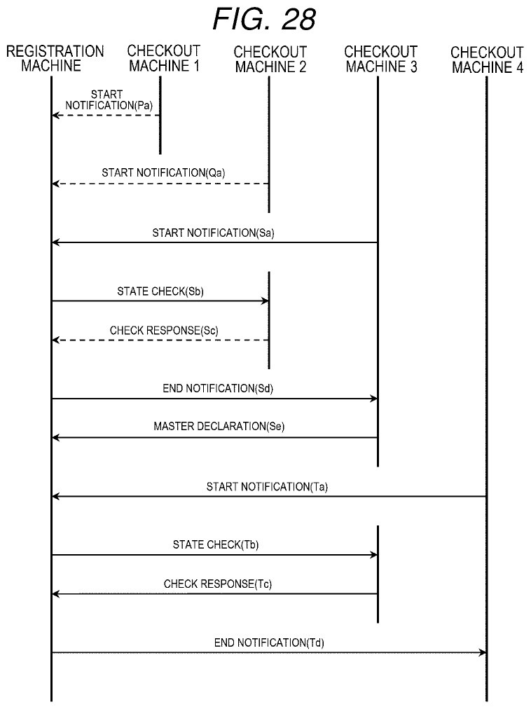

FIG. 28 is a sequence chart at the time when the second checkout machine 12-2 also breaks down. Since the first checkout machine 12-1 and the second checkout machine 12-2 are broken down, the first checkout machine 12-1 and the second checkout machine 12-2 do not transmit the check start notification commands (Pa and Qa). Accordingly, exchange of the state check command (Pb), the check response command (Pc), and the check end notification command (Pd) performed between the registration machine 11 and the first checkout machine 12-1 and exchange of the state check command (Qb), the check response command (Qc), and the check end notification command (Qd) performed between the registration machine 11 and the second checkout machine 12-2 are not performed either.

On the other hand, the check start notification command (Sa) is transmitted from the third checkout machine 12-3. In response to the check start notification command (Sa), the registration machine 11 transmits the state check command (Sb) to the second checkout machine 12-2, which is the transmission destination checkout machine. However, an error occurs in the transmission of the state check command (Sb) and the check response command (Sc) cannot be received. Accordingly, checkout machine information is not included in the check end notification command (Sd) transmitted from the registration machine 11 to the third checkout machine 12-3. The transfer order M (=2) of the second checkout machine 12-2, which is the transmission destination checkout machine, is smaller than the transfer order N (=3) of the third checkout machine 12-3. Therefore, since the transmission destination change condition is satisfied, the third checkout machine 12-3 transmits the master declaration command (Se) to the registration machine 11. As a result, the third checkout machine 12-3 becomes the transmission destination checkout machine 12-X.

Thereafter, if the check start notification command (Ta) is transmitted from the fourth checkout machine 12-4, the registration machine 11 transmits a state check command (Tb) to the third checkout machine 12-3. If receiving a check response command (Tc) from the third checkout machine 12-3, the registration machine 11 transmits a check end notification command (Td) including the checkout machine information and the data of the checkout machine state table 82 to the fourth checkout machine 12-4. At this time, the transfer order M (=3) of the third checkout machine 12-3, which is the transmission destination checkout machine, is lower than the transfer order N (=4) of the fourth checkout machine 12-4. If the checkout machine information does not satisfy the transmission destination change condition, the fourth checkout machine 12-4 does not transmit the master declaration command to the registration machine 11.

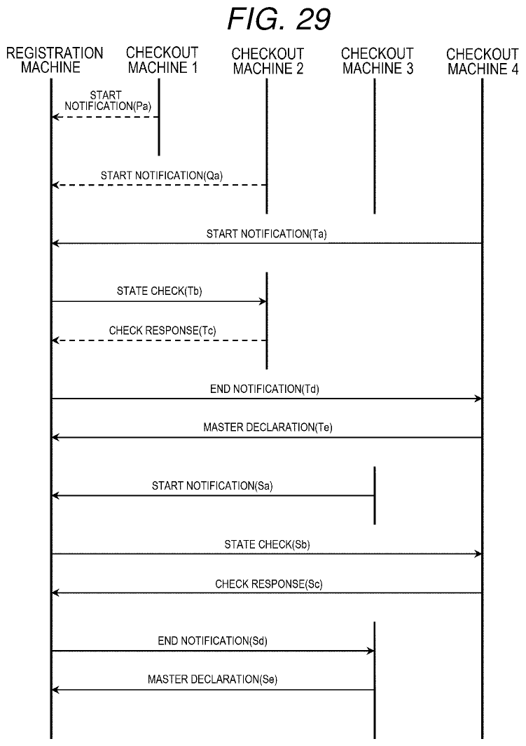

Like FIG. 28, FIG. 29 is a sequence chart at the time when the check start notification command (Ta) is transmitted to the registration machine 11 from the fourth checkout machine 12-4 first if both the first checkout machine 12-1 and the second checkout machine 12-2, which is the transmission destination checkout machine, breaks down.

As illustrated, in response to the check start notification command (Ta) from the fourth checkout machine 12-4, the registration machine 11 transmits the state check command (Tb) to the second checkout machine 12-2. However, an error occurs in the transmission of the state check command (Tb) and the check response command (Tc) cannot be received. Accordingly, checkout machine information is not included in the check end notification command (Td) transmitted from the registration machine 11 to the fourth checkout machine 12-4. The transfer order M (=2) of the second checkout machine 12-2, which is the transmission destination checkout machine, is smaller than the transfer order N (=4) of the fourth checkout machine 12-4. Therefore, since the transmission destination change condition is satisfied, the fourth checkout machine 12-4 transmits a master declaration command (Te) to the registration machine 11. As a result, the fourth checkout machine 12-4 becomes the transmission destination checkout machine 12-X.

Thereafter, if the check start notification command (Sa) is transmitted from the third checkout machine 12-3, the registration machine 11 transmits the state check command (Sb) to the fourth checkout machine 12-4. If receiving the check response command (Sc) from the fourth checkout machine 12-4, the registration machine 11 transmits the check end notification command (Sd) including the checkout machine information and the data of the checkout machine state table 82 to the third checkout machine 12-3. At this time, the transfer order M (=4) of the fourth checkout machine 12-4, which is the transmission destination checkout machine, is larger than the transfer order N (=3) of the third checkout machine 12-3. Therefore, since the transmission destination change condition is satisfied, the third checkout machine 12-3 transmits the master declaration command (Se) to the registration machine 11. As a result, the third checkout machine 12-3 becomes the transmission destination checkout machine 12-X.

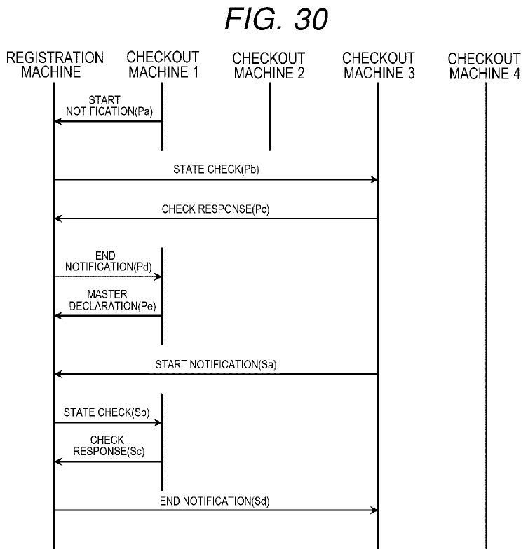

FIG. 30 is a sequence chart at the time when the broken-down first checkout machine 12-1 is restored if the third checkout machine 12-3 is the transmission destination checkout machine 12-X. The restored first checkout machine 12-1 transmits the check start notification command (Pa) to the registration machine 11. In response to the check start notification command (Pa), the registration machine 11 transmits the state check command (Pb) to the third checkout machine 12-3. If receiving the check response command (Pc) from the third checkout machine 12-3, the registration machine 11 transmits the check end notification command (Pd) including the checkout machine information and the data of the checkout machine state table 82 to the first checkout machine 12-1. At this time, the transfer order M (=3) of the third checkout machine 12-3, which is the transmission destination checkout machine, is larger than the transfer order N (=1) of the first checkout machine 12-1. Therefore, since the transmission destination change condition is satisfied, the first checkout machine 12-1 transmits the master declaration command (Pe) to the registration machine 11. As a result, the first checkout machine 12-1 becomes the transmission destination checkout machine 12-X.

Thereafter, if the check start notification command (Sa) is transmitted from the third checkout machine 12-3, the registration machine 11 transmits the state check command (Sb) to the first checkout machine 12-1. If receiving the check response command (Sc) from the first checkout machine 12-1, the registration machine 11 transmits the check end notification command (Sd) including the checkout machine information and the data of the checkout machine state table 82 to the third checkout machine 12-3. At this time, the transfer order M (=1) of the first checkout machine 12-1, which is the transmission destination machine, is smaller than the transfer order N (=3) of the third checkout machine 12-3. If the checkout machine information does not satisfy the transmission destination change condition, the third checkout machine 12-3 does not transmit the master declaration command to the registration machine 11.

In examples of the sequences illustrated in FIGS. 27 to 30, the checkout machine 12-K is illustrated as transmitting the check start notification commands (Pa, Qa, Sa, and Ta) after the check end notification commands (Pd, Qd, Sd, and Td) are transmitted from the registration machine 11. However, timing for transmitting the check start notification commands (Pa, Qa, Sa, and Ta) is not particularly limited. Accordingly, actually, in some case, it could occur that the registration machine 11 receives the check start notification command from another checkout machine 12-K before transmitting the check end notification command to any one of the checkout machines 12-K. In such a case, after transmitting the check end notification command to the one checkout machine 12-K, the registration machine 11 executes processing corresponding to the check start notification command from the other checkout machine 12-K, that is, transmission of a state check command, reception of a check response command, and transmission of a check end notification command.

As explained above in detail, with the transaction processing system 300, even if the transmission destination checkout machine 12-X breaks down and the settlement information cannot be transmitted from the registration machine 11 to the transmission destination checkout machine 12-X, another checkout machine 12-K can be immediately set as the transmission destination checkout machine 12-X. The same holds true if a failure such as a printer error or a change machine error occurs in the transmission destination checkout machine 12-K and settlement cannot be performed. Therefore, even if an abnormality occurs in the transmission destination checkout machine 12-X, it is possible to prevent settlement of a transaction from being delayed. As a result, it is possible to provide a transaction processing system with high processing efficiency.

If the checkout machine 12-K higher in transfer order than the transmission destination checkout machine 12-X at the present point in time is restored, the restored checkout machine 12-K can be quickly reset to the transmission destination checkout machine 12-X. In general, in a semi-self-service type transaction processing system, transfer order of a checkout machine having satisfactory customer movement efficiency tends to be set higher. Therefore, it is possible to minimize influence involved in an abnormality of the checkout machine 12-1 higher in transfer order.

In the third embodiment, as in the second embodiment, different group may share one or more checkout machines. In that case as well, the shared checkout machines transmit the check start notification commands (Qa and Ra) to the registration machines 11 in the groups.

The several embodiments are explained above. However, these embodiments are presented as examples and are not intended to limit the scope of the invention. These new embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

What is claimed is:

1. A transaction processing system, comprising:
an input processing device configured to generate settlement information for a transaction with a customer; and
a first and second settlement device, each configured to execute settlement processing for the transaction according to the settlement information generated by the input processing device, wherein
the input processing device includes a first processor configured to:
send the settlement information to the first settlement device as a primary transmission destination,
perform a status check on the first settlement device and output a status check notification based on the status check, and
change the primary transmission destination from the first settlement device to the second settlement device upon receiving a transmission change notification from the second settlement device; and
the second settlement device includes a second processor configured to:
send a status check request to the input processing device for requesting a status check on the first settlement device, and
send a transmission destination change to the input processing device if the status check notification output in response to the status check request includes information indicating a destination change condition has been met.

2. The transaction processing system according to claim 1, wherein
the first processor is configured to acquire information indicating an operating state of the first settlement device from the first settlement device in the status check, and
the second processor is configured to send the transmission destination change if the status check notification output by the input processing unit indicates the information about the operating state of the first settlement device was not acquired in the status check.

3. The transaction processing system according to claim 1, wherein
the first processor is configured to acquire information indicating an operating state of the first settlement device from the first settlement device in the status check, and
the second processor is configured to send the transmission destination change if the status check notification output by the input processing unit indicates the operating state of the first settlement device is an error state.

4. The transaction processing system according to claim 1, wherein
the first processor is further configured to reset the primary transmission destination for the settlement information to the first settlement device after a change to the second settlement device upon receiving a transmission destination change from the first settlement device.

5. The transaction processing system according to claim 4, wherein the first settlement device includes a third processor configured to:
send status check information to the input processing device in response to a status check notice from the input processing device.

6. The transaction processing system according to claim 4, wherein the input processing device stores a flag value that is switched between a first state in which the primary transmission destination for the settlement information is the first settlement device and a second state in which the primary transmission destination is the second settlement device.

7. The transaction processing system according to claim 4, wherein the first and second settlement devices periodically output a status check request.

8. The transaction processing system according to claim 1, further comprising a third settlement device configured to execute settlement processing for the transaction according to the settlement information generated by the input processing device.

9. The transaction processing system according to claim 1, wherein the first settlement device is configured to forward settlement information to the second settlement device when an operating state of the first settlement device does not permit performance of settlement processing at the first settlement device.

10. The transaction processing system according to claim 1, wherein the first settlement device, the second settlement device, and the input processing device are connected by a wireless network.

11. A transaction processing system, comprising:
a point-of-sale (POS) terminal configured to generate settlement information for a transaction with a customer;
a first settlement device connected to the POS terminal and configured to execute settlement processing for the transaction according to the settlement information generated by the POS terminal; and
a second settlement device connected to the POS terminal and the first settlement device and configured to execute settlement processing for the transaction according to the settlement information generated by the POS terminal, wherein
the POS terminal includes a first processor configured to:
send the settlement information to the one of the first and second settlement devices set as a primary transmission destination,
perform a status check on the one of the first and second settlement devices set as the primary transmission destination and output a status check notification based on the status check, the status check notification indicating an operating state of the one the first and second settlement devices,
change the primary transmission destination from the one of the first and second settlement devices to the other of the first and second settlement devices upon receiving a transmission change notification from the other one of the first and second settlement devices; and
each of the first and second settlement devices includes a second processor configured to:
send a status check request to the POS terminal for requesting a status check on the one of the first and second settlement devices set as the primary transmission destination, and
send a transmission destination change to the POS terminal if the status check notification output in response to the status check request includes information indicating a destination change condition has been met.

12. The transaction processing system according to claim 11, wherein the second processor of each of the first and second settlement devices is further configured to:
transfer the settlement information to the other one of the first and second settlement devices when a present operating state does not permit immediate settlement processing at the one of the first and second settlement device to which the settlement information was initially sent.

13. The transaction processing system according to claim 12, wherein the other one of the first and second settlement devices, which is not set as the primary transmission destination, is configured to output a status check request at regular intervals.

14. The transaction processing system according to claim 11, wherein the other one of the first and second settlement devices, which is not set as the primary transmission destination, is configured to output a status check request at regular intervals.

15. The transaction processing system according to claim 11, wherein the second processor of each of the first and second settlement devices is configured to send a status check request at a startup time.

16. The transaction processing system according to claim 11, wherein the first processor is further configured to reset the primary transmission destination for the settlement information to the first settlement device after a change to the second settlement device upon receiving a transmission destination change from the first settlement device.

17. The transaction processing system according to claim 11, wherein the POS terminal stores a flag value that is switched between a first state in which the primary transmission destination for the settlement information is the first settlement device and a second state in which the primary transmission destination is the second settlement device.

18. A settlement device for a transaction processing system including an input processing device and a plurality of settlement devices, the settlement device comprising:
a processor configured to:
send a status check request to an input processing device for requesting a status check on another settlement device in a plurality of settlement device, the other settlement device being set as a primary transmission destination for settlement information from the input processing device, and
send a transmission destination change to the input processing device to change the primary transmission destination if a status check notification output from the input processing device in response to the status check request includes information indicating a destination change condition has been met.

19. The settlement device according to claim 18, further comprising:
a communication interface for connecting to input processing device and at least one other settlement device in the plurality of settlement devices.

20. The settlement device according to claim 19, further comprising:
a change machine interface for connecting to a change machine for providing change to a costumer settling a transaction at the settlement device.
